(19) United States
(12) Patent Application Publication
(10) Pub. No.: US 2022/0131884 A1
(43) Pub. Date: Apr. 28, 2022

(54) NON-TRANSITORY COMPUTER-READABLE RECORDING MEDIUM, INFORMATION PROCESSING METHOD, AND INFORMATION PROCESSING DEVICE

(71) Applicant: FUJITSU LIMITED, Kawasaki-shi (JP)

(72) Inventor: Tsuyoshi Taniguchi, Katsushika (JP)

(73) Assignee: FUJITSU LIMITED, Kawasaki-shi (JP)

(21) Appl. No.: 17/507,834

(22) Filed: Oct. 22, 2021

(30) Foreign Application Priority Data
Oct. 28, 2020 (JP) 2020-180710

(51) Int. Cl. H04L 29/06

(52) U.S. Cl. CPC H04L 63/1425; H04L 2463/146; H04L 63/145

(57) ABSTRACT

A non-transitory computer-readable recording medium storing a program that causes a computer to execute a process the process includes acquiring malicious behavior data indicating behavior of a malicious domain used for each attack of a plurality of types of attacks, specifying a probability of detecting the behavior when each feature of a plurality of kinds of features that appears in the behavior is utilized to detect the behavior used for the each attack, based on the acquired malicious behavior data, analyzing usefulness of the each feature in detecting the behavior used for the each attack, based on the specified probability, and determining which type of attack among the plurality of types of attacks the malicious domain is used for with regard to behavior of an object domain when corresponding to the behavior of the malicious domain, based on a result of the analyzing.

### CROSS-REFERENCE TO RELATED APPLICATION

This application is based upon and claims the benefit of priority of the prior Japanese Patent Application No. 2020-180710, filed on Oct. 28, 2020, the entire contents of which are incorporated herein by reference.

### FIELD

The embodiments discussed herein are related to a non-transitory computer-readable recording medium, an information processing method, and an information processing device.

### BACKGROUND

Profile information regarding a cyber attack from which damage has already arisen has been disclosed as threat information in the past such that it becomes easier to take countermeasures against cyber attack. For example, it is disclosed as threat information that malicious domains used for cyber attack tend to have a shorter time elapsed from registration than legitimate domains.

There is one example of the prior art in which a category assigned in advance to the domain name is specified based on feature information regarding the domain name, and an attack countermeasure for the domain name is designated step by step according to the specified category. Furthermore, for example, there is a technique that excludes benign domain names from a malicious domain list. In addition, for example, there is a technique that inspects domain data using a multi-domain probability model containing a variable relating to two or more domains, determines the probability distribution of each domain related to the probability model, and allocates a user to a cluster related to the user's job.

International Publication Pamphlet No. WO 2018/163464, Japanese Laid-open Patent Publication No. 2013-3595, and Japanese Laid-open Patent Publication No. 2014-216009 are disclosed as related art.

### SUMMARY

According to an aspect of the embodiments, a non-transitory computer-readable recording medium storing an information processing program that causes a processor included in a computer to execute a process the process includes: acquiring malicious behavior data that indicates behavior of a malicious domain used for each attack of a plurality of types of attacks; specifying a probability of detecting the behavior of the malicious domain when each feature of a plurality of kinds of features that appears in the behavior of the malicious domain is utilized to detect the behavior of the malicious domain used for the each attack, based on the acquired malicious behavior data; analyzing usefulness of the each feature in detecting the behavior of the malicious domain used for the each attack, based on the specified probability; and determining which type of attack among the plurality of types of attacks the malicious domain is used for with regard to behavior of an object domain when corresponding to the behavior of the malicious domain, based on a result of the analyzing.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of an information processing method according to an embodiment;

FIG. 2 is an explanatory diagram illustrating an example of an information processing system 200;

FIG. 3 is a block diagram illustrating a hardware configuration example of an information processing device 100;

FIG. 4 is a block diagram illustrating a functional configuration example of the information processing device 100;

FIG. 5 is a block diagram illustrating a specific functional configuration example of the information processing device 100;

FIG. 6 is an explanatory diagram illustrating an example of generating a basic data management table 521;

FIG. 7 is an explanatory diagram illustrating an example of generating a registrar management table 522;

FIG. 8 is an explanatory diagram illustrating an example of generating a detection result management table 541;

FIG. 9 is an explanatory diagram illustrating an example of how a feature “freshness” appears;

FIG. 10 is an explanatory diagram illustrating an example of how a feature “name server” appears;

FIG. 11 is an explanatory diagram illustrating an example of how a feature “registrar” appears;

FIG. 12 is an explanatory diagram illustrating an example of how a feature “unnatural re-registration” appears;

FIG. 13 is an explanatory diagram illustrating an example of how a feature “forward-lookup long-term delay” appears;

FIG. 14 is an explanatory diagram illustrating an example of generating a per-type feature management table 561;

FIG. 15 is an explanatory diagram (part 1) illustrating an example of determining which type of attack a malicious domain is used for with regard to the behavior of a diagnosis object domain when corresponding to the behavior of the malicious domain;

FIG. 16 is an explanatory diagram (part 2) illustrating an example of determining which type of attack a malicious domain is used for with regard to the behavior of a diagnosis object domain when corresponding to the behavior of the malicious domain;

FIG. 17 is a flowchart illustrating an example of a collection processing procedure;

FIG. 18 is a flowchart illustrating an example of a test processing procedure;

FIG. 19 is a flowchart illustrating an example of a comparison processing procedure; and

FIG. 20 is a flowchart illustrating an example of a diagnostic processing procedure.

### DESCRIPTION OF EMBODIMENTS

In the prior art, it is sometimes difficult to take countermeasures against cyber attack with. For example, threat information corresponding to a cyber attack under investigation is supposed to be located from an enormous amount of threat information, which will lead to an increase in workload imposed when countermeasures against cyber attacks are taken.

In one aspect, it is an object of the present embodiment to reduce the workload imposed when countermeasures against cyber attacks are taken.

Hereinafter, embodiments of an information processing program, an information processing method, and an information processing device will be described in detail with reference to the drawings.

(Example of Information Processing Method According to Embodiment)

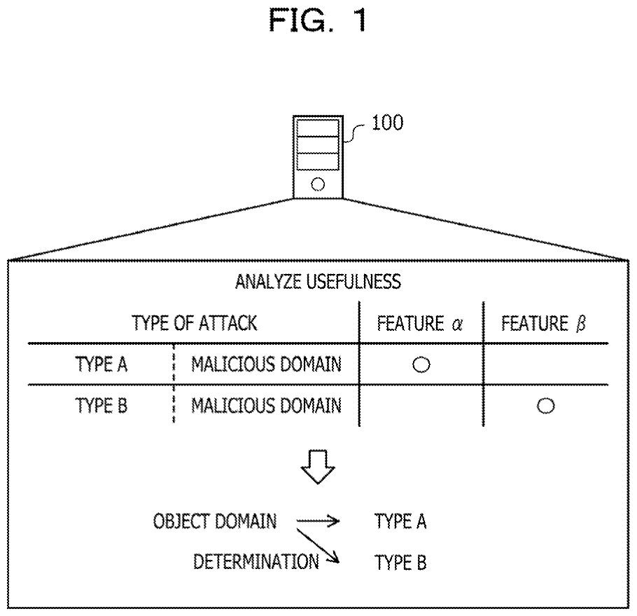

FIG. 1 is an explanatory diagram illustrating an example of an information processing method according to an embodiment. An information processing device 100 is a computer that may allow countermeasures against cyber attack using a malicious domain to be taken more easily. The malicious domain is a domain used for cyber attack. The malicious domain is, for example, a domain relevant to a website that attempts to steal personal information.

Profile information regarding a cyber attack from which damage has already arisen has been disclosed as threat information in the past such that it becomes easier to take countermeasures against cyber attack. For example, it is disclosed as threat information that malicious domains tend to have a shorter time elapsed from registration than legitimate domains. The threat information is, for example, cyber threat intelligence (CTI).

Then, in some cases, a security officer takes countermeasures against cyber attack by locating threat information corresponding to a cyber attack that occurred this time from among pieces of threat information, in response to an alert for cyber attack. The alert indicates that a possibility of a cyber attack has been detected. The security officer is, for example, security operation center (SOC) personnel.

However, it is sometimes difficult to take countermeasures against cyber attack. For example, when the amount of threat information is enormous, there is a disadvantage that it is difficult for the security officer to locate threat information corresponding to a cyber attack that occurred this time from the enormous amount of threat information, which will lead to an increase in workload and working time imposed when countermeasures against cyber attacks are taken. Furthermore, the security officer experiences a large number of alerts a day in some cases, which will bring about a status in which it is difficult to expand the amount of working time spent for every single alert.

In addition, in some cases, the security officer has to explain to a responsible party the cause of the occurrence of the alert, the countermeasures against cyber attacks, and the like. The responsible party is, for example, the management. Here, for example, there is a case where the security officer proposes to stop a network environment affected by a cyber attack as a countermeasure against the cyber attack. At this time, the security officer has to explain to the responsible party the reason why the network environment, which is, properly, not wanted to be stopped in terms of operation or management, has to be stopped. For this reason, there is a disadvantage that an increase in the workload and working time imposed on the security officer is prompted.

In contrast to this, for example, an approach of performing machine learning of a detector that detects a malicious domain used in a cyber attack is conceivable. For example, an approach of performing machine learning of the detector by utilizing a predetermined feature relating to passive domain name system (DNS) data is conceivable. Examples of the predetermined feature include time-based features, DNS answer-based features, time-to-live (TTL) value-based features, and domain name-based features. Regarding this approach, for example, the following Bilge, Leyla, et al., “EXPOSURE: Finding Malicious Domains Using Passive DNS Analysis”, Ndss, 2011, the following Weimer, Florian, “Passive DNS replication”, FIRST conference on computer security incident, 2005, and the like can be referenced.

Furthermore, for example, an approach of performing machine learning of a detector that detects a malicious domain used for a cyber attack by utilizing a predetermined feature relating to WHOIS data is conceivable. The predetermined feature is, for example, a feature that belongs to categories such as domain profile features, registration history features, and batch correlation features. Regarding this approach, for example, the following Hao, Shuang, et al., “PREDATOR: proactive recognition and elimination of domain abuse at time-of-registration”, Proceedings of the 2016 ACM SIGSAC Conference on Computer and Communications Security, 2016, and the like can be referenced.

However, in consideration of the utilization of the above features, attackers are performing evasive actions such that a malicious domain used for a cyber attack is hard to be detected. For example, when performing a targeted attack aiming at a specified organization, an attacker performs an evasive action to bring the operational status of the malicious domain closer to the operational status of the legitimate domain such that a malicious domain used for the targeted attack is hard to be detected. Accordingly, each of the above approaches has a disadvantage that it is difficult to detect a malicious domain used for the targeted attack.

Furthermore, each of the above approaches is intended to detect the malicious domain, and tends not to indicate from what viewpoint the malicious domain is verified. In addition, each of the above approaches is intended to detect the malicious domain, and tends not to indicate what type of cyber attack the malicious domain is used for. For this reason, there is a disadvantage that it is difficult to reduce the workload and working time imposed on the security officer.

Thus, in the present embodiment, an information processing method that may allow the determination on what type of cyber attack the malicious domain is used for and can allow countermeasures against cyber attack using the malicious domain to be taken more easily will be described. In the following description, a cyber attack will be sometimes simply referred to as an “attack”.

In the example in FIG. 1, the information processing device 100 is set with a plurality of types for classifying attacks. For example, the plurality of types includes a targeted type, a wide-area type, and the like. The targeted type is, for example, a type of attack aiming at a specified individual or a specified organization. Therefore, for example, the targeted attack tends to operate the malicious domain over a medium to long term such that the malicious domain becomes hard to be detected by the object of attack. The wide-area type is, for example, a type of attack aiming at an unspecified individual or an unspecified organization. For example, the wide-area type aims at a large number of individuals and expects a successful attack on some of the large number of individuals. Therefore, for example, the wide-area attack tends to treat the malicious domain as disposable and tends to operate the malicious domain in a short term. In the example in FIG. 1, the information processing device 100 is set with a type A and a type B.

In the example in FIG. 1, the information processing device 100 is set with each kind of feature of a plurality of kinds of features that can appear in the behavior of the malicious domain. The plurality of kinds of features includes, for example, a feature that the elapsed time from a time point when the domain was registered is shorter than a threshold value. The plurality of kinds of features includes, for example, a feature that a time taken until the forward lookup for name resolution for a domain was carried out after the domain was registered is longer than a threshold value. In the example in FIG. 1, the information processing device 100 is set with a feature a and a feature β.

(1-1) The information processing device 100 acquires malicious behavior data that indicates the behavior of a malicious domain used for each type of attack. The information processing device 100 acquires, for example, a plurality of pieces of malicious behavior data that indicates the behavior of a malicious domain used for a type A attack. Furthermore, the information processing device 100 acquires, for example, a plurality of pieces of malicious behavior data that indicates the behavior of a malicious domain used for a type B attack.

(1-2) The information processing device 100 calculates the probability of detecting the behavior of the malicious domain when it is assumed that each kind of feature is utilized to detect the behavior of the malicious domain used for each type of attack, based on the acquired pieces of malicious behavior data. The information processing device 100 calculates the probability that the behavior of the malicious domain can be detected, for example, when it is assumed that the feature a is utilized to detect the behavior of a malicious domain used for the type A attack. Furthermore, the information processing device 100 calculates the probability that the behavior of the malicious domain can be detected, for example, when it is assumed that the feature β is utilized to detect the behavior of the malicious domain used for the type A attack.

In addition, the information processing device 100 calculates the probability that the behavior of the malicious domain can be detected, for example, when it is assumed that the feature a is utilized to detect the behavior of a malicious domain used for the type B attack. In addition, the information processing device 100 calculates the probability that the behavior of the malicious domain can be detected, for example, when it is assumed that the feature β is utilized to detect the behavior of the malicious domain used for the type B attack.

(1-3) The information processing device 100 analyzes the usefulness of each kind of feature in detecting the behavior of the malicious domain used for each type of attack, based on the calculated probability of the detection. The information processing device 100 analyzes, for example, that the feature a is relatively useful in detecting the behavior of the malicious domain used for the attack of the type A among the types A and B. Furthermore, the information processing device 100 analyzes, for example, that the feature β is relatively useful in detecting the behavior of the malicious domain used for the attack of the type B among the types A and B.

(1-4) Based on the result of the analysis, the information processing device 100 determines which type of attack among the plurality of types of attacks a malicious domain is used for with regard to the behavior of the object domain when corresponding to the behavior of the malicious domain. Based on the result of the analysis, for example, the information processing device 100 determines whether or not the behavior of the object domain corresponds to the behavior of the malicious domain used for the type A attack, by utilizing the feature a that appears in the behavior of the object domain. Furthermore, based on the result of the analysis, for example, the information processing device 100 determines whether or not the behavior of the object domain corresponds to the behavior of the malicious domain used for the type B attack, by utilizing the feature β that appears in the behavior of the object domain.

(1-5) The information processing device 100 outputs the result of the determination in association with the object domain. Furthermore, the information processing device 100 outputs a feature relevant to the result of the determination, among the features of the respective kinds, in association with the object domain. The feature relevant to the result of the determination is, for example, a feature utilized when it was determined that the behavior of the object domain corresponds to the behavior of the malicious domain. Therefore, the output feature indicates the basis for determining that the behavior of the object domain corresponds to the behavior of the malicious domain.

Consequently, the information processing device 100 may allow countermeasures against attacks to be taken more easily and may reduce the workload and working time imposed when countermeasures against attacks are taken. The information processing device 100 may allow the security officer to grasp, for example, which type of attack among the plurality of types of attacks the malicious domain is used for with regard to the behavior of the object domain when corresponding to the behavior of the malicious domain. Furthermore, the information processing device 100 may allow the security officer to grasp, for example, a feature that is the basis for determining that the behavior of the object domain corresponds to the behavior of the malicious domain.

Therefore, the information processing device 100 may allow the security officer to mitigate the need for referring to the threat information and may reduce the workload and working time imposed on the security officer. Furthermore, the information processing device 100 may reduce the working time spent for every single alert by the security officer. In addition, the information processing device 100 may make it easier for the security officer to explain to the responsible party the feature that is the basis for determining that the behavior of the object domain corresponds to the behavior of the malicious domain.

Based on the fact that the strength of the effectiveness of each feature in detecting the behavior of the malicious domain used for each type of attack is different per type, the information processing device 100 may analyze the usefulness of each feature in detecting the behavior of the malicious domain. Therefore, the information processing device 100 may be allowed to specify, per type, which feature is appropriate to utilize when detecting the behavior of the malicious domain used for the attack of the type. Then, the information processing device 100 may determine, per type, whether or not the behavior of the object domain corresponds to the behavior of the malicious domain, by utilizing the feature verified to be appropriate. Therefore, the information processing device 100 may be allowed to accurately determine, per type, whether or not the behavior of the object domain corresponds to the behavior of the malicious domain.

Here, there may be a case where the information processing device 100 further analyzes the usefulness of each kind of feature in detecting the behavior of the malicious domain used for each type of attack, based also on the behavior of a legitimate domain in addition to the behavior of the malicious domain. For example, the information processing device 100 calculates the probability of erroneously detecting the behavior of the legitimate domain as the behavior of the malicious domain when it is assumed that each kind of feature is utilized to detect the behavior of the malicious domain, based on the behavior of the legitimate domain. Then, the information processing device 100 analyzes the usefulness of each kind of feature in detecting the behavior of the malicious domain used for each type of attack, based on the probability of the erroneous detection. In consequence, the information processing device 100 may allow to accurately determine, per type, which feature is suitable for detecting the behavior of the malicious domain.

Here, a case where, based on the result of the analysis, the information processing device 100 determines which type of attack among the plurality of types of attacks the malicious domain is used for with regard to the behavior of the object domain when corresponding to the behavior of the malicious domain has been described. However, the present embodiment is not limited to this case. For example, there may be a case where the information processing device 100 further determines whether or not the behavior of the object domain corresponds to the behavior of the legitimate domain, based on the result of the analysis. For example, based on the result of the analysis, the information processing device 100 determines that the behavior of the object domain corresponds to the behavior of the legitimate domain, if the behavior of the object domain does not correspond to the behavior of the malicious domain used for any type of attack among the plurality of types of attacks.

In this manner, the information processing device 100 is applied to a situation for determining whether or not the behavior of the object domain corresponds to the behavior of the legitimate domain or which type of attack the malicious domain is used for with regard to the behavior of the object domain when corresponding to the behavior of the malicious domain. In this case, it is considered preferable that the information processing device 100 analyzes the usefulness of each feature based on both of legitimate behavior data and the malicious behavior data.

Meanwhile, the information processing device 100 may be applied to a situation in which the object domain is considered to be a malicious domain and it is determined which type of attack the malicious domain is used for with regard to the behavior of the object domain when corresponding to the behavior of the malicious domain. In this case, the information processing device 100 may analyze the usefulness of each feature based only on the malicious behavior data.

(One Example of Information Processing System 200)

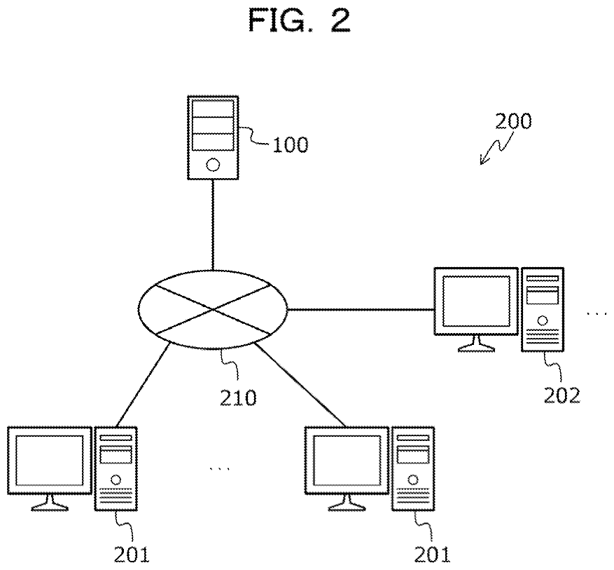

Next, an example of an information processing system 200 to which the information processing device 100 illustrated in FIG. 1 is applied will be described with reference to FIG. 2.

FIG. 2 is an explanatory diagram illustrating an example of the information processing system 200. In FIG. 2, the information processing system 200 includes the information processing device 100, client devices 201, and an information management device 202.

In the information processing system 200, the information processing device 100 and the client devices 201 are connected via a wired or wireless network 210. Examples of the network 210 include a local area network (LAN), a wide area network (WAN), and the Internet. Furthermore, in the information processing system 200, the information processing device 100 and the information management device 202 are connected via the wired or wireless network 210.

The information processing device 100 collects the malicious behavior data from the information management device 202. The information processing device 100 collects the legitimate behavior data that indicates the behavior of the legitimate domain, from the information management device 202. The information processing device 100 receives object behavior data that indicates the behavior of the object domain, from the client device 201. The information processing device 100 analyzes the usefulness of each kind of feature in detecting the behavior of the malicious domain used for each type of attack, based on the malicious behavior data and the legitimate behavior data.

If the behavior of the object domain corresponds to the behavior of the malicious domain based on the result of the analysis with reference to the object behavior data, the information processing device 100 determines which type of attack among the plurality of types of attacks the malicious domain is used for with regard to the behavior of the object domain when corresponding to the behavior of the malicious domain. At this time, the information processing device 100 determines that the behavior of the object domain corresponds to the behavior of the legitimate domain if the behavior of the object domain does not correspond to the behavior of the malicious domain used for any type of attack among the plurality of types of attacks.

The information processing device 100 transmits the result of the determination to the client device 201 that is the transmission source of the object behavior data, in association with the object domain. When it is determined that the behavior of the object domain corresponds to the behavior of the malicious domain used for any type of attack, the information processing device 100 transmits a feature utilized in the determination to the client device 201 that is the transmission source of the object behavior data, in association with the object domain. Furthermore, examples of the information processing device 100 include a server and a personal computer (PC).

The client device 201 is a computer used by the security officer. The client device 201 is, for example, a computer used by SOC personnel. The client device 201 transmits the object behavior data that indicates the behavior of the object domain to the information processing device 100, based on an operation input from the security officer.

As a result of the transmission, the client device 201 receives, from the information processing device 100, a result of determining which type of malicious domain among the plurality of types of malicious domains has the behavior corresponding to the behavior of the object domain. As a result of the transmission, the client device 201 may receive, from the information processing device 100, the result of determining that the behavior of the object domain corresponds to the behavior of the legitimate domain.

The client device 201 outputs a result of determining which type of malicious domain among the plurality of types of malicious domains has the behavior corresponding to the behavior of the object domain, in a manner that allows the security officer to refer to the result. Furthermore, the client device 201 outputs the result of determining that the behavior of the object domain corresponds to the behavior of the legitimate domain, in a manner that allows the security officer to refer to the result. Examples of the client device 201 include a server, a PC, a tablet terminal, and a smartphone.

The information management device 202 is a computer that manages the malicious behavior data and the legitimate behavior data. The information management device 202 transmits the malicious behavior data and the legitimate behavior data to the information processing device 100. The information management device 202 is, for example, a server, a PC, or the like.

The information processing system 200 includes, for example, the information processing device 100, the client device 201 used by SOC personnel, and the information management device 202 owned by an organization that provides the CTI. This allows the information processing system 200 to make it easier for SOC personnel to take countermeasures against attacks.

Here, a case where the information processing device 100 and the client device 201 are different devices has been described, but the present embodiment is not limited to this case. For example, there may be a case where the information processing device 100 has a function as the client device 201. In this case, the information processing system 200 may not include the client device 201.

Here, a case where the information processing device 100 and the information management device 202 are different devices has been described, but the present embodiment is not limited to this case. For example, there may be a case where the information processing device 100 has a function as the information management device 202. In this case, the information processing system 200 may not include the information management device 202.

(Hardware Configuration Example of Information Processing Device 100)

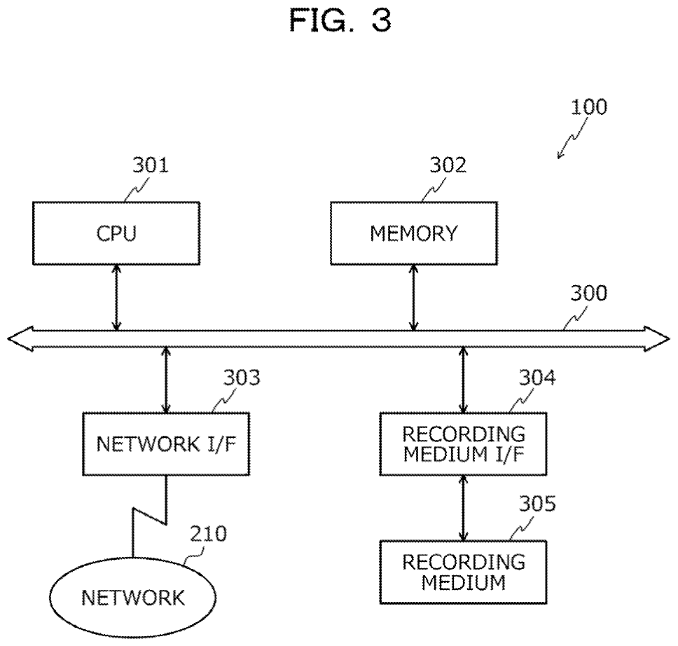

Next, a hardware configuration example of the information processing device 100 will be described with reference to FIG. 3.

FIG. 3 is a block diagram illustrating a hardware configuration example of the information processing device 100. In FIG. 3, the information processing device 100 includes a central processing unit (CPU) 301, a memory 302, a network interface (I/F) 303, a recording medium I/F 304, and a recording medium 305. Furthermore, the individual components are connected to each other by a bus 300.

Here, the CPU 301 is in charge of overall control of the information processing device 100. For example, the memory 302 includes a read only memory (ROM), a random access memory (RAM), a flash ROM, and the like. For example, the flash ROM or the ROM stores various programs, and the RAM is used as a work area for the CPU 301. The programs stored in the memory 302 are loaded into the CPU 301 to cause the CPU 301 to execute coded processing.

The network I/F 303 is connected to the network 210 through a communication line, and is connected to another computer via the network 210. Then, the network I/F 303 is in charge of an interface between the network 210 and the inside, and controls input and output of data to and from another computer. Examples of the network I/F 303 include a modem and a LAN adapter.

The recording medium I/F 304 controls read and write of data to and from the recording medium 305 under the control of the CPU 301. Examples of the recording medium I/F 304 include a disk drive, a solid state drive (SSD), and a universal serial bus (USB) port. The recording medium 305 is a nonvolatile memory that stores data written under the control of the recording medium I/F 304. Examples of the recording medium 305 include a disk, a semiconductor memory, and a USB memory. The recording medium 305 may be removably installed on the information processing device 100.

For example, the information processing device 100 may include a keyboard, a mouse, a display, a printer, a scanner, a microphone, a speaker, or the like in addition to the above-described components. Furthermore, the information processing device 100 may include a plurality of the recording medium I/F 304 and the recording media 305. Alternatively, the information processing device 100 may not include the recording medium I/F 304 or the recording medium 305.

(Hardware Configuration Example of Client Device 201)

Since the hardware configuration example of the client device 201 is similar to the hardware configuration example of the information processing device 100 illustrated in FIG. 3, the description thereof is omitted.

(Hardware Configuration Example of Information Management Device 202)

Since the hardware configuration example of the information management device 202 is similar to the hardware configuration example of the information processing device 100 illustrated in FIG. 3, the description thereof is omitted.

(Functional Configuration Example of Information Processing Device 100)

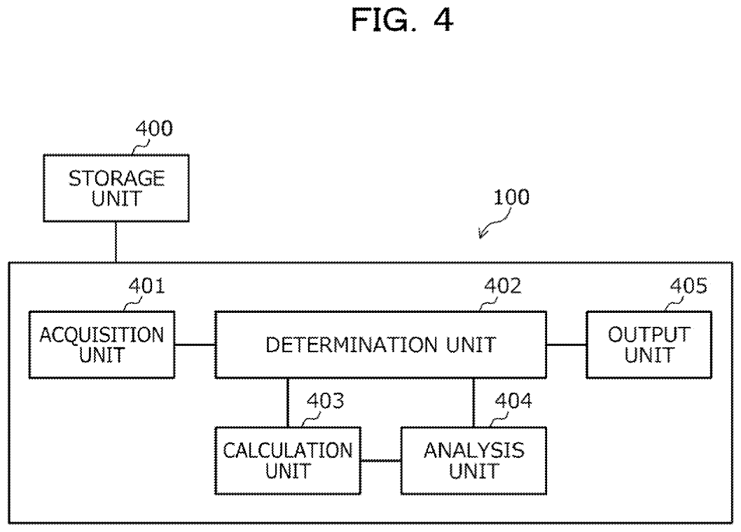

Next, a functional configuration example of the information processing device 100 will be described with reference to FIG. 4.

FIG. 4 is a block diagram illustrating a functional configuration example of the information processing device 100. The information processing device 100 includes a storage unit 400, an acquisition unit 401, a determination unit 402, a calculation unit 403, an analysis unit 404, and an output unit 405.

The storage unit 400 is implemented by a storage area of the memory 302, the recording medium 305, or the like illustrated in FIG. 3, for example. Hereinafter, a case where the storage unit 400 is included in the information processing device 100 will be described. However, the present embodiment is not limited to this case. For example, there may be a case where the storage unit 400 is included in a device different from the information processing device 100, and the information processing device 100 is allowed to refer to contents stored in the storage unit 400.

The acquisition unit 401 to the output unit 405 function as an example of a control unit. For example, the acquisition unit 401 to the output unit 405 implement functions thereof by causing the CPU 301 to execute a program stored in a storage area of the memory 302, the recording medium 305, or the like or by the network I/F 303 illustrated in FIG. 3. A processing result of each functional unit is stored in a storage area of the memory 302, the recording medium 305, or the like illustrated in FIG. 3, for example.

The storage unit 400 stores various sorts of information referred to or updated in the processing of each functional unit. The storage unit 400 stores a plurality of types into which attacks are classified. For example, the plurality of types includes a targeted type, a wide-area type, and the like. The targeted type is, for example, a type of attack aiming at a specified individual or a specified organization. The wide-area type is, for example, a type of attack aiming at an unspecified individual or an unspecified organization.

The storage unit 400 is set with each kind of feature of a plurality of kinds of features that can appear in the behavior of the malicious domain. The plurality of kinds of features includes, for example, a first feature that the elapsed time from a time point when a domain was registered is shorter than a first threshold value. The first threshold value is one year.

When the domain is a legitimate domain, the domain tends to be operated over a comparatively long term, and thus the elapsed time from a time point when the domain was registered tends to be comparatively long. On the other hand, when the domain is a malicious domain, the domain tends to be operated for a comparatively short term and treated as disposable, and thus the elapsed time from a time point when the domain was registered tends to be comparatively short. Accordingly, it is deemed that the first feature is utilizable as a feature that can appear in the behavior of the malicious domain.

The plurality of kinds of features includes, for example, a second feature that a period of time during which a name server used when operating a domain was operated in a case where the name servers were switched one or more times is shorter than a second threshold value. The second threshold value is, for example, one year.

When the domain is a legitimate domain, a name server used when operating the domain tends not to be switched over a comparatively long term, and thus a period of time during which the name server is operated tends to be comparatively long. Therefore, even if the name server is switched one or more times when operating the domain, a period of time during which the name server is operated tends to be comparatively long. On the other hand, when the domain is a malicious domain, a name server used when operating the domain tends to be frequently switched, and thus a period of time during which the name server is operated tends to be very short. Accordingly, it is deemed that the second feature is utilizable as a feature that can appear in the behavior of the malicious domain.

The plurality of kinds of features includes, for example, a third feature that the remaining expiration of a domain according to a registrar used when operating the domain before the domain is re-registered is longer than a third threshold value. The third threshold value is, for example, one month.

When the domain is a legitimate domain, a registrar used when operating the domain tends not to be switched over a comparatively long term, and thus the re-registration of the domain is unlikely to occur. Furthermore, when the domain is a legitimate domain, even if a registrar used when operating the domain is switched, the registrar tends to be switched for transfer. For example, a registrar used when operating the domain tends to be switched for transfer at a timing when the remaining expiration of the domain according to the registrar expires.

On the other hand, when the domain is a malicious domain, the domain is sometimes re-registered. Moreover, when the domain is a malicious domain, a registrar used when operating the domain is sometimes switched before the remaining expiration of the domain according to the registrar used when operating the domain expires. Accordingly, it is deemed that the third feature is utilizable as a feature that can appear in the behavior of the malicious domain.

The plurality of kinds of features includes, for example, a fourth feature that a time taken until a domain was re-registered after the domain was invalidated is longer than a fourth threshold value. The fourth threshold value is, for example, one year.

When the domain is a legitimate domain, the domain tends to be operated with care such that the domain is not invalidated in order to suppress drop catch. On the other hand, when the domain is a malicious domain, there is a case where the domain is invalidated, and the domain is sometimes re-registered after being invalidated. Accordingly, it is deemed that the fourth feature is utilizable as a feature that can appear in the behavior of the malicious domain.

The plurality of kinds of features includes, for example, a fifth feature that a time taken until the forward lookup for name resolution for a domain was carried out after the domain was registered is longer than a fifth threshold value. The fifth threshold value is, for example, one year.

When the domain is a legitimate domain, the forward lookup for name resolution for the domain tends to be carried out immediately after the domain was registered. For example, “immediately after” means a few minutes, a few hours, or the like later. On the other hand, when the domain is a malicious domain, the forward lookup for name resolution for the domain is sometimes carried out after a long time has elapsed since the domain was registered. Accordingly, it is deemed that the fifth feature is utilizable as a feature that can appear in the behavior of the malicious domain.

The storage unit 400 stores a rule for determining whether or not the behavior of a certain domain corresponds to the behavior of the malicious domain by utilizing each kind of feature of the plurality of kinds of features. The storage unit 400 stores a rule that indicate how to determine whether or not the behavior of a certain domain corresponds the behavior of the malicious domain by utilizing each of the first feature, the second feature, the third feature, the fourth feature, and the fifth feature.

The acquisition unit 401 acquires various sorts of information to be used for the processing of each functional unit. The acquisition unit 401 stores the acquired various sorts of information in the storage unit 400 or outputs the acquired various sorts of information to each functional unit. Furthermore, the acquisition unit 401 may output the various sorts of information stored in the storage unit 400 to each functional unit. The acquisition unit 401 acquires the various sorts of information based on, for example, a user's operation input.

The acquisition unit 401 may receive the various sorts of information from a device different from the information processing device 100, for example.

The acquisition unit 401 acquires the malicious behavior data that indicates the behavior of the malicious domain used for each type of attack of a plurality of types of attacks. The acquisition unit 401 acquires, for example, a plurality of pieces of malicious behavior data that indicates the behavior of a malicious domain used for the wide-area attack. Furthermore, the acquisition unit 401 acquires, for example, a plurality of pieces of malicious behavior data that indicates the behavior of a malicious domain used for the targeted attack.

For example, the acquisition unit 401 acquires the malicious behavior data that indicates the behavior of the malicious domain used for the wide-area attack by receiving the malicious behavior data from the information management device 202. For example, the acquisition unit 401 acquires the malicious behavior data that indicates the behavior of the malicious domain used for the targeted attack by receiving the malicious behavior data from the information management device 202.

More precisely, the acquisition unit 401 inquires of the information management device 202 about the malicious behavior data that indicates the behavior of the malicious domain used for the wide-area attack, at a timing when a specified operation input is made by the user, and collects the inquired malicious behavior data from the information management device 202. More precisely, the acquisition unit 401 inquires of the information management device 202 about the malicious behavior data that indicates the behavior of the malicious domain used for the targeted attack, at a timing when a specified operation input is made by the user, and collects the inquired malicious behavior data from the information management device 202.

More precisely, the acquisition unit 401 may receive the malicious behavior data that indicates the behavior of the malicious domain used for the wide-area attack, which has been actively transmitted by the information management device 202, at every predetermined timing. More precisely, the acquisition unit 401 may receive the malicious behavior data that indicates the behavior of the malicious domain used for the targeted attack, which has been actively transmitted by the information management device 202, at every predetermined timing. This allows the acquisition unit 401 to obtain information that enables the analysis of to what extent each kind of feature is useful in detecting each type of malicious domain.

The acquisition unit 401 acquires the legitimate behavior data that indicates the behavior of the legitimate domain. The acquisition unit 401 acquires, for example, a plurality of pieces of legitimate behavior data that indicates the behavior of the legitimate domain. For example, the acquisition unit 401 acquires the legitimate behavior data by receiving the legitimate behavior data from the information management device 202.

More precisely, the acquisition unit 401 inquires of the information management device 202 about the legitimate behavior data that indicates the behavior of the legitimate domain, at a timing when a specified operation input is made by the user, and collects the inquired legitimate behavior data from the information management device 202. More precisely, the acquisition unit 401 may receive the legitimate behavior data that indicates the behavior of the legitimate domain, which has been actively transmitted by the information management device 202, at every predetermined timing. This allows the acquisition unit 401 to obtain information that enables the analysis of to what extent each kind of feature is useful in detecting each type of malicious domain.

The acquisition unit 401 acquires the object behavior data that indicates the behavior of the object domain. The acquisition unit 401 acquires, for example, one or more pieces of object behavior data that indicates the behavior of the object domain. For example, the acquisition unit 401 acquires the object behavior data by receiving the object behavior data from the client device 201. This allows the acquisition unit 401 to obtain the object behavior data that indicates the behavior of the object domain, which is an object to be diagnosed as to which type of malicious domain has the behavior corresponding to the behavior of the object domain.

The acquisition unit 401 may accept a start trigger to start the processing of any of the functional units. The start trigger is, for example, a predetermined operation input made by the user. The start trigger may be, for example, reception of predetermined information from another computer. The start trigger may be, for example, output of predetermined information by any of the functional units.

For example, the acquisition unit 401 may accept the fact that the malicious behavior data and the legitimate behavior data have been acquired, as a start trigger to start the processing of the calculation unit 403 and the analysis unit 404. For example, the acquisition unit 401 may accept the fact that the acquired malicious behavior data and legitimate behavior data have exceeded a particular amount, as a start trigger to start the processing of the calculation unit 403 and the analysis unit 404. For example, the acquisition unit 401 may accept the fact that a predetermined operation input by the user has been made, as a start trigger to start the processing of the calculation unit 403 and the analysis unit 404.

For example, the acquisition unit 401 may accept the fact that the object behavior data has been acquired, as a start trigger to start the processing of the determination unit 402. For example, the acquisition unit 401 may accept the fact that the acquired object behavior data has exceeded a particular amount, as a start trigger to start the processing of the determination unit 402. For example, the acquisition unit 401 may accept the fact that a predetermined operation input by the user has been made, as a start trigger to start the processing of the determination unit 402.

Based on the acquired malicious behavior data, the determination unit 402 examines whether or not the behavior of the malicious domain is correctly determined to correspond to the behavior of the malicious domain when each kind of feature is utilized. The determination unit 402 examines, for example, per malicious behavior data that indicates the behavior of the malicious domain used for the wide-area attack, whether or not the behavior of the malicious domain indicated by the malicious behavior data is correctly determined to correspond to the behavior of the malicious domain when each kind of feature is utilized. For example, in accordance with the rule stored in the storage unit 400, the determination unit 402 determines whether or not the behavior of the malicious domain used for the wide-area attack, which is indicated by the malicious behavior data, corresponds to the behavior of the malicious domain when each kind of feature is utilized.

The determination unit 402 examines, for example, per malicious behavior data that indicates the behavior of the malicious domain used for the targeted attack, whether or not the behavior of the malicious domain indicated by the malicious behavior data is correctly determined to correspond to the behavior of the malicious domain when each kind of feature is utilized. For example, in accordance with the rule stored in the storage unit 400, the determination unit 402 determines whether or not the behavior of the malicious domain used for the targeted attack, which is indicated by the malicious behavior data, corresponds to the behavior of the malicious domain when each kind of feature is utilized. This allows the determination unit 402 to obtain information that enables the analysis of to what extent each kind of feature is useful in detecting the behavior of the malicious domain used for which type of attack.

Based on the acquired legitimate behavior data, the determination unit 402 examines whether or not the behavior of the legitimate domain is erroneously determined to correspond to the behavior of the malicious domain when each kind of feature is utilized. The determination unit 402 examines, for example, per legitimate behavior data, whether or not the behavior of the legitimate domain indicated by the legitimate behavior data is erroneously determined to correspond to the behavior of the malicious domain when each kind of feature is utilized.

For example, in accordance with the rule stored in the storage unit 400, the determination unit 402 determines whether or not the behavior of the legitimate domain indicated by the legitimate behavior data corresponds to the behavior of the legitimate domain when each kind of feature is utilized. In consequence, the determination unit 402 may allow to evaluate the degree of probability of causing erroneous detection when detecting the behavior of the malicious domain used for each type of attack by utilizing each kind of feature. Therefore, the determination unit 402 is allowed to obtain information that enables the analysis of to what extent each kind of feature is useful in detecting the behavior of the malicious domain used for which type of attack.

The calculation unit 403 calculates the probability of detecting the behavior of the malicious domain when it is assumed that each kind of feature is utilized to detect the behavior of the malicious domain used for each type of attack. For example, the calculation unit 403 calculates, as a probability, the percentage of malicious behavior data correctly determined to correspond to the behavior of the malicious domain, to a plurality of pieces of malicious behavior data that each indicates the behavior of the malicious domain used for the wide-area attack, when each kind of feature is utilized. For example, the calculation unit 403 calculates the probability based on the determination result of the determination unit 402.

For example, the calculation unit 403 calculates, as a probability, the percentage of malicious behavior data correctly determined to correspond to the behavior of the malicious domain, to a plurality of pieces of malicious behavior data that each indicates the behavior of the malicious domain used for the targeted attack, when each kind of feature is utilized. For example, the calculation unit 403 calculates the probability based on the determination result of the determination unit 402. This allows the calculation unit 403 to obtain an index value that indicates to what extent each kind of feature is useful in detecting the behavior of the malicious domain used for each type of attack.

The calculation unit 403 calculates the probability of erroneously detecting the behavior of the legitimate domain as the behavior of the malicious domain when it is assumed that each kind of feature is utilized to detect the behavior of the malicious domain. The calculation unit 403 calculates, as a probability, the percentage of legitimate behavior data erroneously determined to correspond to the behavior of the malicious domain, to a plurality of pieces of legitimate behavior data that indicates the behavior of the legitimate domain, when each kind of feature is utilized. For example, the calculation unit 403 calculates the probability based on the determination result of the determination unit 402. This allows the calculation unit 403 to obtain an index value that indicates to what extent each kind of feature is useful in detecting the behavior of the malicious domain used for each type of attack.

The analysis unit 404 analyzes the usefulness of each kind of feature in detecting the behavior of the malicious domain used for each type of attack, based on the calculated probability of the detection. For example, the analysis unit 404 analyzes which type of attack among a plurality of types of attacks a malicious domain is used for with regard to each kind of feature when being useful in detecting the behavior of the malicious domain, based on the calculated probability of the detection.

For example, the analysis unit 404 specifies each kind of feature as being most useful in detecting the behavior of the malicious domain used for one type of attack for which the highest calculated probability of the detection is given among the plurality of types of attacks. This allows the analysis unit 404 to specify which feature can be utilized to determine whether or not the behavior of the object domain corresponds to the behavior of the malicious domain used for each type of attack.

The analysis unit 404 may analyze the usefulness of each kind of feature in detecting the behavior of the malicious domain used for each type of attack, based on the calculated probability of the detection and the calculated probability of the erroneous detection.

The analysis unit 404 determines, for example, whether or not the calculated probability of the erroneous detection is equal to or higher than a predetermined probability for each kind of feature, based on the calculated probability of the erroneous detection. Then, if one of the features has a probability equal to or higher than the predetermined probability, the analysis unit 404 analyzes that the one of the features is not useful in detecting the behavior of the malicious domain used for any type of attack among the plurality of types of attacks.

On the other hand, if one of the features has a probability less than the predetermined probability, the analysis unit 404 analyzes which type of attack among a plurality of types of attacks the malicious domain is used for with regard to the one of the features when being useful in detecting the behavior of the malicious domain, based on the calculated probability of the detection. In consequence, the analysis unit 404 may allow to specify which feature is concerning to a possibility that, when utilized, the behavior of the object domain is erroneously determined to correspond to the behavior of the malicious domain.

Based on the result of the analysis, the determination unit 402 determines which type of attack among the plurality of types of attacks the malicious domain is used for with regard to the behavior of the object domain when corresponding to the behavior of the malicious domain. For example, as a result of the analysis, a case where the first feature is useful in detecting the behavior of the malicious domain used for the wide-area attack is conceivable. In this case, the determination unit 402 determines, for example, whether or not the behavior of the object domain corresponds to the behavior of the malicious domain used for the wide-area attack, by utilizing the first feature.

For example, as a result of the analysis, a case where the second feature is useful in detecting the behavior of the malicious domain used for the wide-area attack is conceivable. In this case, the determination unit 402 determines, for example, whether or not the behavior of the object domain corresponds to the behavior of the malicious domain used for the wide-area attack, by utilizing the second feature.

For example, as a result of the analysis, a case where the third feature is useful in detecting the behavior of the malicious domain used for the targeted attack is conceivable. In this case, the determination unit 402 determines, for example, whether or not the behavior of the object domain corresponds to the behavior of the malicious domain used for the targeted attack, by utilizing the third feature.

For example, as a result of the analysis, a case where the fourth feature is useful in detecting the behavior of the malicious domain used for the targeted attack is conceivable. In this case, the determination unit 402 determines, for example, whether or not the behavior of the object domain corresponds to the behavior of the malicious domain used for the targeted attack, by utilizing the fourth feature.

For example, as a result of the analysis, a case where the fifth feature is useful in detecting the behavior of the malicious domain used for the targeted attack is conceivable. In this case, the determination unit 402 determines, for example, whether or not the behavior of the object domain corresponds to the behavior of the malicious domain used for the targeted attack, by utilizing the fifth feature. This allows the determination unit 402 to accurately determine which type of attack the malicious domain is used for with regard to the behavior of the object domain when corresponding to the behavior of the malicious domain.

Based on the result of the analysis, the determination unit 402 determines that the behavior of the object domain corresponds to the behavior of the legitimate domain, if the behavior of the object domain does not correspond to the behavior of the malicious domain used for any type of attack among the plurality of types of attacks. This allows the determination unit 402 to accurately determine that the behavior of the object domain corresponds to the behavior of the legitimate domain.

When the behavior of the object domain does not correspond to the behavior of the malicious domain used for any type of attack among the plurality of types of attacks based on the result of the analysis, the determination unit 402 may not have to determine that the behavior of the object domain corresponds to the behavior of the legitimate domain. In this case, for example, the determination unit 402 may not make the determination as corresponding to the behavior of the legitimate domain because a feature with a low certainty of corresponding to the behavior of the malicious domain used for each type of attack does not regularly have a high certainty of corresponding to the behavior of the legitimate domain.

The output unit 405 outputs a processing result of at least any of the functional units. An output format is, for example, display on a display, print output to a printer, transmission to an external device by the network I/F 303, or storage to the storage area of the memory 302, the recording medium 305, or the like. In consequence, the output unit 405 may allow to notify the user of the processing result of at least one of the functional units and may improve the convenience of the information processing device 100.

The output unit 405 outputs the result of the determination in association with the object domain. For example, the output unit 405 transmits, to the client device 201, which type of attack the malicious domain is used for with regard to the behavior of the object domain when corresponding to the behavior of the malicious domain, in association with the object domain.

In consequence, the output unit 405 may allow the security officer to easily grasp which type of attack the malicious domain is used for with regard to the behavior of the object domain when corresponding to the behavior of the malicious domain. Therefore, the output unit 405 may make it easier for the security officer to take countermeasures against the attack, or make it easier for the security officer to explain to the responsible party the attack. Then, the output unit 405 may reduce the workload and working time imposed on the security officer.

The output unit 405 outputs a feature relevant to the result of the determination, among the features of the respective kinds, in association with the object domain. The feature relevant to the result of the determination is, for example, a feature verified to be useful in detecting the behavior of the malicious domain used for any type of attack, to which the behavior of the object domain is determined to correspond. Therefore, the output feature indicates a feature that can be the basis for determining that the behavior of the object domain corresponds to the behavior of the malicious domain. The output unit 405 transmits, for example, the feature relevant to the result of the determination to the client device 201 in association with the object domain.

In consequence, the output unit 405 may allow the security officer to easily grasp a feature that can be the basis for determining that the behavior of the object domain corresponds to the behavior of the malicious domain. Therefore, the output unit 405 may make it easier for the security officer to take countermeasures against the attack, or make it easier for the security officer to explain to the responsible party the attack. Then, the output unit 405 may reduce the workload and working time imposed on the security officer.

The output unit 405 outputs the probability of detecting the behavior of the malicious domain when it is assumed that the feature relevant to the result of the determination among the features of the respective kinds is utilized to detect the behavior of the malicious domain, in association with the object domain. The probability of the detection indicates, for example, the likelihood as the basis for determining that the behavior of the object domain corresponds to the behavior of the malicious domain. For example, the output unit 405 transmits, to the client device 201, the probability of detecting the behavior of the malicious domain when it is assumed that the feature relevant to the result of the determination is utilized to detect the behavior of the malicious domain, in association with the object domain.

In consequence, the output unit 405 may allow the security officer to easily grasp to what extent the feature that can be the basis for determining that the behavior of the object domain corresponds to the behavior of the malicious domain is important as a viewpoint. Therefore, the output unit 405 may make it easier for the security officer to take countermeasures against the attack, or make it easier for the security officer to explain to the responsible party the attack. Then, the output unit 405 may reduce the workload and working time imposed on the security officer.

(Specific Functional Configuration Example of Information Processing Device 100)

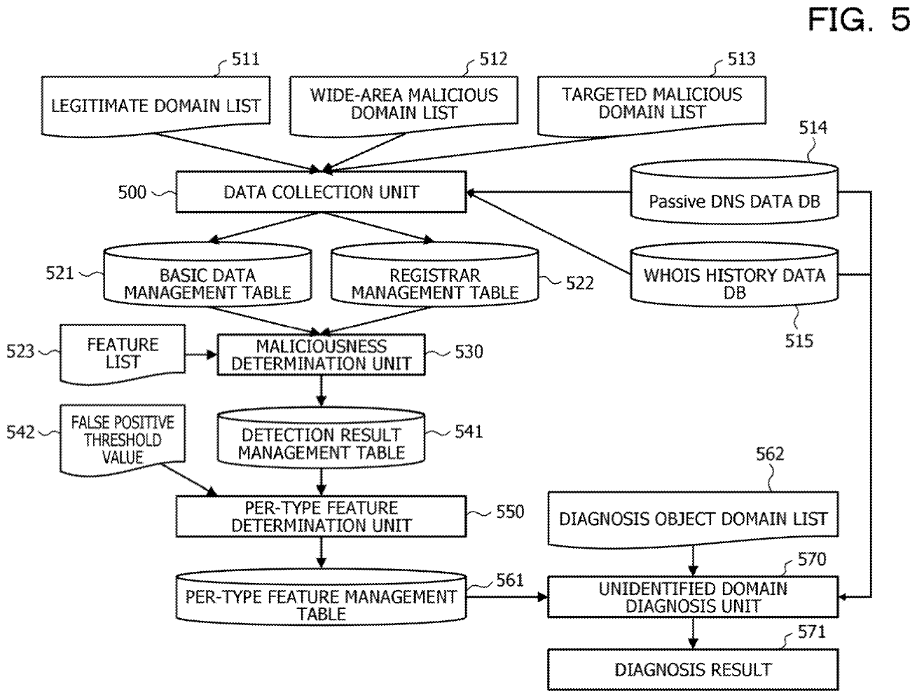

Next, a specific functional configuration example of the information processing device 100 will be described with reference to FIG. 5.

FIG. 5 is a block diagram illustrating a specific functional configuration example of the information processing device 100. In FIG. 5, the information processing device 100 includes a data collection unit 500. The data collection unit 500 implements, for example, the acquisition unit 401 illustrated in FIG. 4.

The data collection unit 500 acquires a legitimate domain list 511, a wide-area malicious domain list 512, and a targeted malicious domain list 513.

The legitimate domain list 511 indicates a legitimate domain operated by legitimate business in a specifiable manner. The wide-area malicious domain list 512 indicates a malicious domain used for the wide-area attack in a specifiable manner. The wide-area malicious domain list 512 is generated, for example, based on threat information. For example, the wide-area attack is botnet, spam, or the like. The targeted malicious domain list 513 indicates a malicious domain used for the targeted attack in a specifiable manner. The targeted malicious domain list 513 is generated, for example, based on threat information.

The data collection unit 500 refers to the legitimate domain list 511 to collect passive DNS data relating to the legitimate domain from a passive DNS data database (DB) 514, and saves the collected passive DNS data in a basic data management table 521. The passive DNS data indicates, for example, what timing a name resolution query was issued.

Furthermore, the data collection unit 500 refers to the wide-area malicious domain list 512 to collect passive DNS data relating to the wide-area malicious domain from the passive DNS data DB 514, and saves the collected passive DNS data in the basic data management table 521.

In addition, the data collection unit 500 refers to the targeted malicious domain list 513 to collect passive DNS data relating to the targeted malicious domain from the passive DNS data DB 514, and saves the collected passive DNS data in the basic data management table 521.

The data collection unit 500 refers to the legitimate domain list 511 to collect WHOIS history data relating to the legitimate domain from a WHOIS history data DB 515, and saves the collected WHOIS history data in the basic data management table 521 and the registrar management table 522. The WHOIS history data indicates, for example, how domain registration has changed.

Furthermore, the data collection unit 500 refers to the wide-area malicious domain list 512 to collect WHOIS history data relating to the wide-area malicious domain from the WHOIS history data DB 515. The data collection unit 500 saves the collected WHOIS history data relating to the wide-area malicious domain in the basic data management table 521 and the registrar management table 522.

In addition, the data collection unit 500 refers to the targeted malicious domain list 513 to collect WHOIS history data relating to the targeted malicious domain from the WHOIS history data DB 515. The data collection unit 500 saves the collected WHOIS history data relating to the targeted malicious domain in the basic data management table 521 and the registrar management table 522.

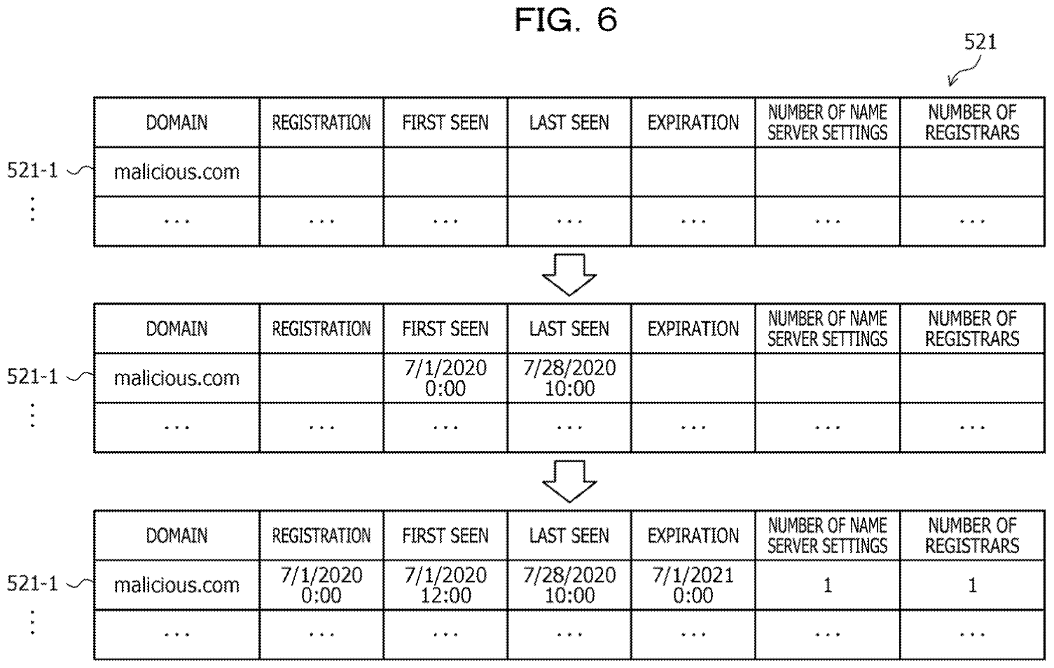

In this fashion, the data collection unit 500 generates the basic data management table. An example of generating the basic data management table 521 will be described later precisely with reference to FIG. 6.

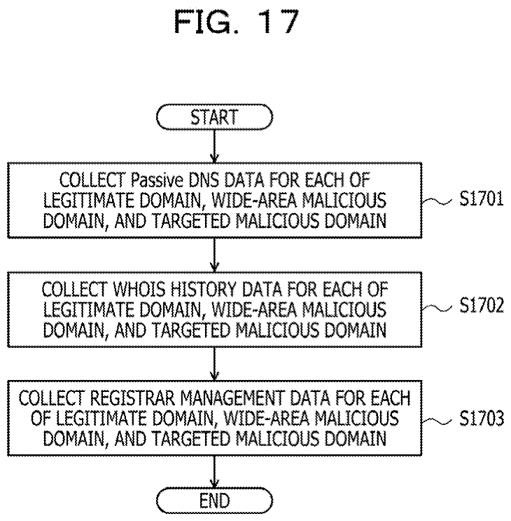

Furthermore, a flow of processing of generating the basic data management table 521 will be described later precisely with reference to FIG. 17.

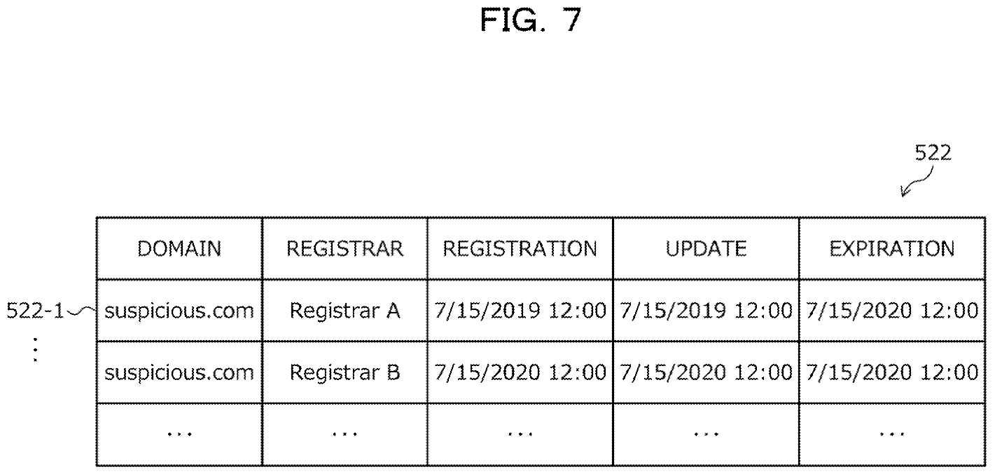

Furthermore, in this fashion, the data collection unit 500 generates the registrar management table 522. An example of generating the registrar management table 522 will be described later precisely with reference to FIG. 7.

In addition, a flow of processing of generating the registrar management table 522 will be described later precisely with reference to FIG. 17.

The information processing device 100 includes a maliciousness determination unit 530. The maliciousness determination unit 530 implements, for example, the determination unit 402 and the calculation unit 403 illustrated in FIG. 4.

The maliciousness determination unit 530 acquires the basic data management table 521 and the registrar management table 522. Furthermore, the maliciousness determination unit 530 acquires a feature list 523. The feature list 523 indicates a plurality of kinds of features that can be utilized when determining whether or not the behavior of a certain domain corresponds to the behavior of the malicious domain, in a specifiable manner. In addition, the feature list 523 includes a rule that defines how to determine whether or not the behavior of a certain domain corresponds to the behavior of the malicious domain by utilizing each kind of feature of the plurality of kinds of features.

The maliciousness determination unit 530 refers to the feature list 523 to calculate a false positive rate when it is assumed that each kind of feature is utilized for detecting the malicious domain, based on the basic data management table 521 and the registrar management table 522. The false positive rate is, for example, a probability that the behavior of the legitimate domain is erroneously determined to be the behavior of the malicious domain. The maliciousness determination unit 530 saves the calculated false positive rate in a detection result management table 541.

Furthermore, the maliciousness determination unit 530 refers to the feature list 523 to calculate a detection rate when it is assumed that each kind of feature is utilized for detecting the wide-area malicious domain, based on the basic data management table 521 and the registrar management table 522. The detection rate is the percentage of behaviors of wide-area malicious domains correctly determined to correspond to behaviors of the malicious domains, to behaviors of respective wide-area malicious domains of a plurality of wide-area malicious domains registered in the wide-area malicious domain list 512. The maliciousness determination unit 530 saves the calculated detection rate in the detection result management table 541.

Furthermore, the maliciousness determination unit 530 refers to the feature list 523 to calculate a detection rate when it is assumed that each kind of feature is utilized for detecting the targeted malicious domain, based on the basic data management table 521 and the registrar management table 522. The detection rate is the percentage of behaviors of targeted malicious domains correctly determined to correspond to behaviors of the malicious domains, to behaviors of respective targeted malicious domains of a plurality of targeted malicious domains registered in the targeted malicious domain list 513. The maliciousness determination unit 530 saves the calculated detection rate in the detection result management table 541.

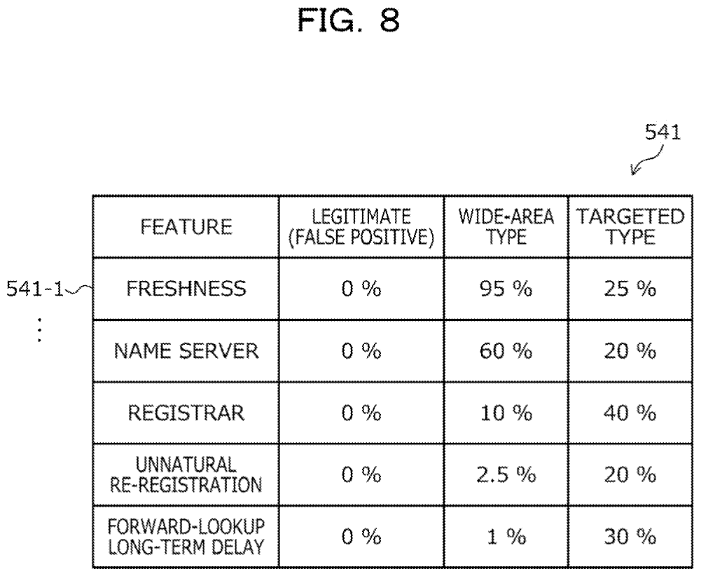

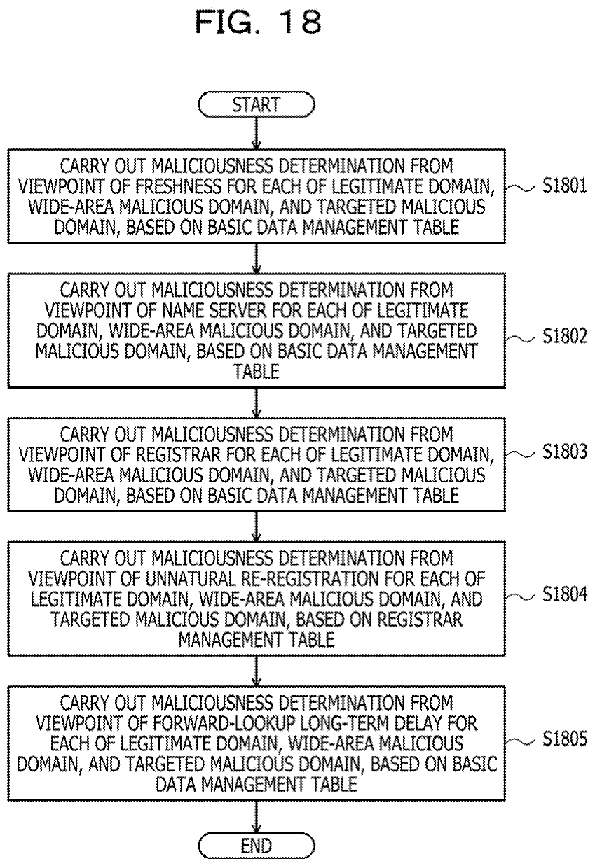

In this fashion, the maliciousness determination unit 530 generates the detection result management table 541. An example of generating the detection result management table 541 will be described later precisely with reference to FIG. 8. Furthermore, a flow of processing of generating the detection result management table 541 will be described later precisely with reference to FIG. 18.

The information processing device 100 includes a per-type feature determination unit 550. The per-type feature determination unit 550 implements, for example, the analysis unit 404 illustrated in FIG. 4.

The per-type feature determination unit 550 acquires the detection result management table 541. In addition, the per-type feature determination unit 550 acquires a false positive threshold value 542. The per-type feature determination unit 550 refers to the false positive threshold value 542 to analyze which type of attack the malicious domain is used for with regard to each kind of feature when being useful in detecting the behavior of the malicious domain, based on the detection result management table 541.

The per-type feature determination unit 550 determines whether or not the calculated false positive rate is equal to or lower than the false positive threshold value 542 for each kind of feature. If one kind of feature has a calculated false positive rate greater than the false positive threshold value 542, the per-type feature determination unit 550 determines the one kind of feature as a kind of feature that prompts an incident in which the behavior of the legitimate domain is erroneously determined to be the behavior of the malicious domain. For this reason, the per-type feature determination unit 550 determines that any kind of feature that has a false positive rate greater than the false positive threshold value 542 is not useful in detecting the behavior of the malicious domain used for any type of attack, and it is preferable not to utilize such a kind of feature.

On the other hand, if one kind of feature has a calculated false positive rate equal to or lower than the false positive threshold value 542, the per-type feature determination unit 550 analyzes which type of attack the malicious domain is used for with regard to the one kind of feature when being most useful in detecting the behavior of the malicious domain. The per-type feature determination unit 550 specifies, for example, a type with which the highest calculated detection rate is given for one kind of feature that has a false positive rate equal to or lower than the false positive threshold value 542. Then, the per-type feature determination unit 550 analyzes, for example, that the one kind of feature is most useful in detecting the behavior of the malicious domain used for the specified type of attack.

The per-type feature determination unit 550 saves the result of the analysis in a per-type feature management table 561. As a result of the analysis, for example, the per-type feature determination unit 550 saves, in the per-type feature management table 561, which type of attack the malicious domain is used for with regard to each kind of feature when being most useful in detecting the behavior of the malicious domain, in association with each kind of feature.

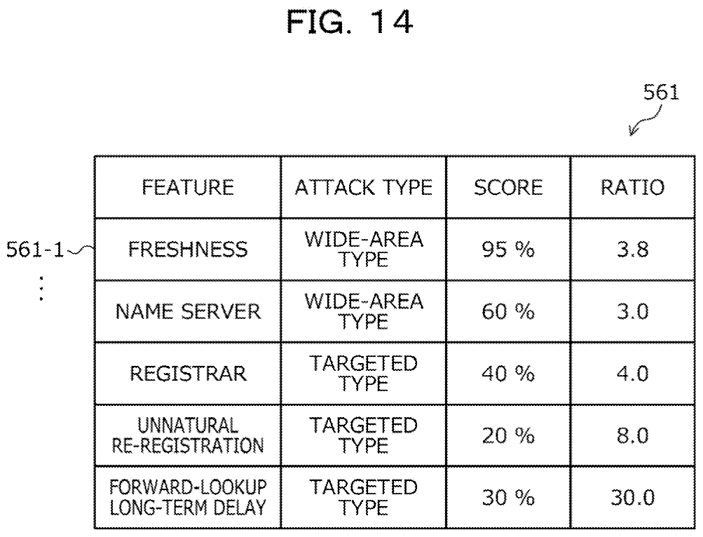

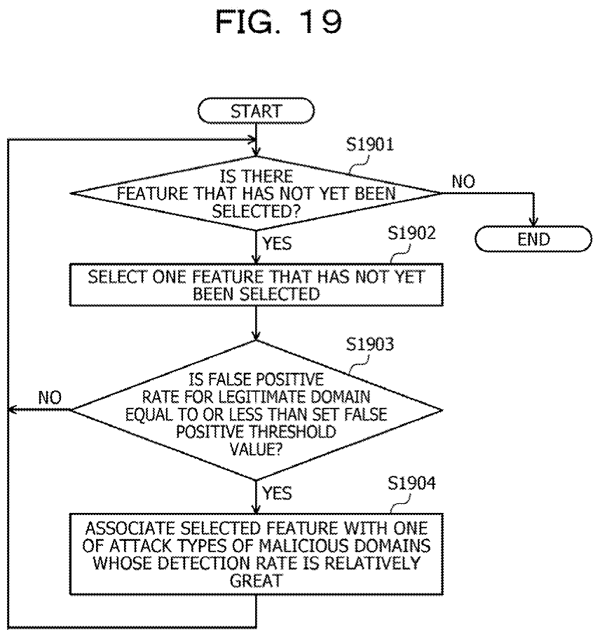

Thus, the per-type feature determination unit 550 generates the per-type feature management table 561. An example of generating the per-type feature management table 561 will be described later precisely with reference to FIG. 14. Furthermore, a flow of processing of generating the per-type feature management table 561 will be described later precisely with reference to FIG. 19.

The information processing device 100 includes an unidentified domain diagnosis unit 570. The unidentified domain diagnosis unit 570 implements, for example, the determination unit 402 illustrated in FIG. 4.

The unidentified domain diagnosis unit 570 acquires the per-type feature management table 561. The unidentified domain diagnosis unit 570 acquires a diagnosis object domain list 562. The diagnosis object domain list 562 indicates a diagnosis object domain, which is unknown as to whether or not to be a malicious domain, in a specifiable manner. The diagnosis object domain is a diagnosis object for whether or not the behavior of the diagnosis object domain corresponds to the behavior of the malicious domain.

The unidentified domain diagnosis unit 570 collects passive DNS data relating to the diagnosis object domain from the passive DNS data DB 514, based on the diagnosis object domain list 562. Furthermore, the unidentified domain diagnosis unit 570 collects WHOIS history data relating to the diagnosis object domain from the WHOIS history data DB 515, based on the diagnosis object domain list 562.

By utilizing every one kind of feature, the unidentified domain diagnosis unit 570 diagnoses whether or not the behavior of the diagnosis object domain corresponds to the behavior of a malicious domain used for one type of attack associated with the one kind of feature in the per-type feature management table 561.

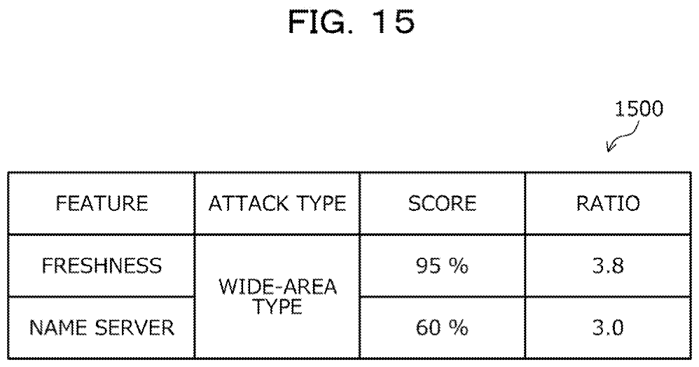

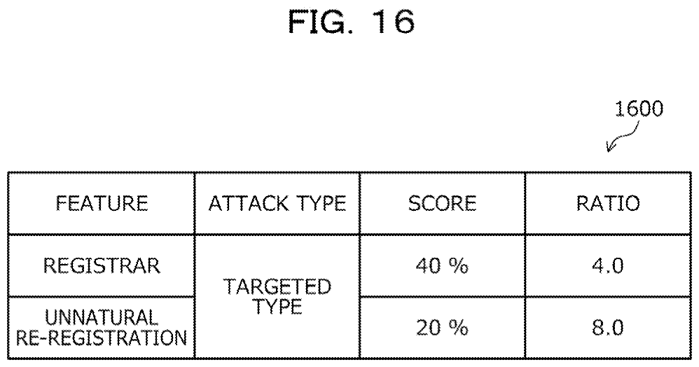

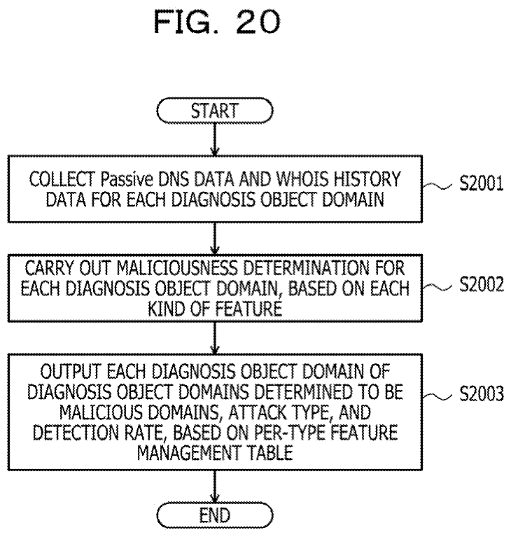

The unidentified domain diagnosis unit 570 outputs a diagnosis result 571. The diagnosis result 571 includes, for example, which type of attack the malicious domain is used for with regard to the behavior of the diagnosis object domain when corresponding to the behavior of the malicious domain. An example of the diagnosis will be described later precisely with reference to FIGS. 15 and 16. A flow of processing of the diagnosis will be described later precisely with reference to FIG. 20.

(Action Example of Information Processing Device 100)

Next, an action example of the information processing device 100 will be described with reference to FIGS. 6 to 16. For example, first, an example in which the information processing device 100 collects the passive DNS data and the WHOIS history data to generate the basic data management table 521 will be described with reference to FIG. 6.

FIG. 6 is an explanatory diagram illustrating an example of generating the basic data management table 521. The basic data management table 521 is implemented by a storage area of the memory 302, the recording medium 305, or the like of the information processing device 100 illustrated in FIG. 3, for example.

As illustrated in FIG. 6, the basic data management table 521 has fields for domain, registration, first seen, last seen, expiration, number of name server settings, and number of registrars. In the basic data management table 521, basic data is stored as a record 521-a by setting information in each field per domain. The letter a denotes any integer.

The field for domain is set with a domain. The field for registration is set with the registration date and time when the above domain was registered by a registrar who first managed the above domain. The field for first seen is set with a time point when the oldest address (A) record relating to the above domain was first observed by DNS forward lookup. The field for last seen is set with a time point when the latest A record relating to the above domain was observed most recently by DNS forward lookup. When there is one A record, a time point when the A record was first observed is set in the field for first seen, and a time point when the A record was observed most recently is set in the field for last seen. The field for expiration is set with a valid registration period of the above domain by a registrar who recently managed the above domain. The field for the number of name server settings is set with the number of times name servers set for the above domain in the past have been switched. The field for the number of registrars is set with the number of registrars who have managed the above domain in the past.

In FIG. 6, the data collection unit 500 acquires the legitimate domain list 511, the wide-area malicious domain list 512, and the targeted malicious domain list 513. The data collection unit 500 refers to the legitimate domain list 511 to set the legitimate domain in the field for domain in the basic data management table 521. The data collection unit 500 collects passive DNS data relating to the legitimate domain from the passive DNS data DB 514.

Based on the passive DNS data relating to the legitimate domain, the data collection unit 500 sets a time point when the oldest A record relating to the above domain was first observed by DNS forward lookup, in the field for first look in the basic data management table 521. Furthermore, based on the passive DNS data relating to the legitimate domain, the data collection unit 500 sets a time point when the latest A record relating to the above domain was observed most recently by DNS forward lookup, in the field for last seen in the basic data management table 521.

The data collection unit 500 collects WHOIS history data relating to the legitimate domain from the WHOIS history data DB 515. Based on the WHOIS history data relating to the legitimate domain, the data collection unit 500 sets the registration date and time when the above domain was registered by a registrar who first managed the above domain, in the field for registration in the basic data management table 521. Based on the WHOIS history data relating to the legitimate domain, the data collection unit 500 sets the valid registration period of the above domain by a registrar who recently managed the above domain, in the field for expiration in the basic data management table 521.

Based on the WHOIS history data relating to the legitimate domain, the data collection unit 500 sets the number of times name servers set for the above domain in the past have been switched, in the field for the number of name server settings in the basic data management table 521. Here, in the operation of the domain, it tends to be usually performed to set a plurality of name servers including an alternative name server. Meanwhile, when an attacker operates a name server, the whole setting of the name server is sometimes switched in a short period of time. Therefore, it is preferable that the number of name server settings not be the number of name servers but the number of times name servers have been switched.

Based on the WHOIS history data relating to the legitimate domain, the data collection unit 500 sets the number of registrars who managed the above domain in the past, in the field for the number of registrars in the basic data management table 521.

Furthermore, the data collection unit 500 refers to the wide-area malicious domain list 512 to set the wide-area malicious domain in the field for domain in the basic data management table 521. The data collection unit 500 collects passive DNS data relating to the wide-area malicious domain from the passive DNS data DB 514.

Based on the passive DNS data relating to the wide-area malicious domain, the data collection unit 500 sets a time point when the oldest A record relating to the above domain was first observed by DNS forward lookup, in the field for first look in the basic data management table 521. In addition, based on the passive DNS data relating to the wide-area malicious domain, the data collection unit 500 sets a time point when the latest A record relating to the above domain was observed most recently by DNS forward lookup, in the field for last seen in the basic data management table 521.

The data collection unit 500 collects WHOIS history data relating to the wide-area malicious domain from the WHOIS history data DB 515. Based on the WHOIS history data relating to the wide-area malicious domain, the data collection unit 500 sets the registration date and time when the above domain was registered by a registrar who first managed the above domain, in the field for registration in the basic data management table 521. Based on the WHOIS history data relating to the wide-area malicious domain, the data collection unit 500 sets the valid registration period of the above domain by a registrar who recently managed the above domain, in the field for expiration in the basic data management table 521.

Based on the WHOIS history data relating to the wide-area malicious domain, the data collection unit 500 sets the number of times name servers set for the above domain in the past have been switched, in the field for the number of name server settings in the basic data management table 521.

Based on the WHOIS history data relating to the wide-area malicious domain, the data collection unit 500 sets the number of registrars who managed the above domain in the past, in the field for the number of registrars in the basic data management table 521.

Furthermore, the data collection unit 500 refers to the targeted malicious domain list 513 to set the targeted malicious domain in the field for domain in the basic data management table 521. The data collection unit 500 collects passive DNS data relating to the targeted malicious domain from the passive DNS data DB 514.

Based on the passive DNS data relating to the targeted malicious domain, the data collection unit 500 sets a time point when the oldest A record relating to the above domain was first observed by DNS forward lookup, in the field for first look in the basic data management table 521. In addition, based on the passive DNS data relating to the targeted malicious domain, the data collection unit 500 sets a time point when the latest A record relating to the above domain was observed most recently by DNS forward lookup, in the field for last seen in the basic data management table 521.

The data collection unit 500 collects WHOIS history data relating to the targeted malicious domain from the WHOIS history data DB 515. Based on the WHOIS history data relating to the targeted malicious domain, the data collection unit 500 sets the registration date and time when the above domain was registered by a registrar who first managed the above domain, in the field for registration in the basic data management table 521. Based on the WHOIS history data relating to the targeted malicious domain, the data collection unit 500 sets the valid registration period of the above domain by a registrar who recently managed the above domain, in the field for expiration in the basic data management table 521.

Based on the WHOIS history data relating to the targeted malicious domain, the data collection unit 500 sets the number of times name servers set for the above domain in the past have been switched, in the field for the number of name server settings in the basic data management table 521.

Based on the WHOIS history data relating to the targeted malicious domain, the data collection unit 500 sets the number of registrars who managed the above domain in the past, in the field for the number of registrars in the basic data management table 521.

Next, an example in which the information processing device 100 collects registrar management data to generate the registrar management table 522 will be described with reference to FIG. 7.

FIG. 7 is an explanatory diagram illustrating an example of generating the registrar management table 522. The registrar management table 522 is implemented by a storage area of the memory 302, the recording medium 305, or the like of the information processing device 100 illustrated in FIG. 3, for example.

As illustrated in FIG. 7, the registrar management table 522 has fields for domain, registrar, registration, update, and expiration. In the registrar management table 522, the registrar management data is stored as a record 522-b by setting information in each field per domain. The letter b denotes any integer.

The field for domain is set with a domain. The field for registrar is set with a registrar used to register the above domain. The field for registration is set with a registration time point when the above registrar registered the above domain. The field for update is set with a time point when the above registrar updated the above domain. The field for expiration is set with the valid registration period of the above domain according to the above registrar.

In FIG. 7, the data collection unit 500 refers to the legitimate domain list 511 to set the legitimate domain in the field for domain in the registrar management table 522. Based on the WHOIS history data relating to the legitimate domain, the data collection unit 500 sets a registrar used to register the above domain, in the field for registrar in the registrar management table 522.

Based on the WHOIS history data relating to the legitimate domain, the data collection unit 500 sets a registration time point when the above registrar registered the above domain, in the field for registration in the registrar management table 522. Based on the WHOIS history data relating to the legitimate domain, the data collection unit 500 sets a time point when the above registrar updated the above domain, in the field for update in the registrar management table 522. Based on the WHOIS history data relating to the legitimate domain, the data collection unit 500 sets the valid registration period of the above domain according to the above registrar, in the field for expiration in the registrar management table 522.

The data collection unit 500 refers to the wide-area malicious domain list 512 to set the wide-area malicious domain in the field for domain in the registrar management table 522. Based on the WHOIS history data relating to the wide-area malicious domain, the data collection unit 500 sets a registrar used to register the above domain, in the field for registrar in the registrar management table 522.

Based on the WHOIS history data relating to the wide-area malicious domain, the data collection unit 500 sets a registration time point when the above registrar registered the above domain, in the field for registration in the registrar management table 522. Based on the WHOIS history data relating to the wide-area malicious domain, the data collection unit 500 sets a time point when the above registrar updated the above domain, in the field for update in the registrar management table 522. Based on the WHOIS history data relating to the wide-area malicious domain, the data collection unit 500 sets the valid registration period of the above domain according to the above registrar, in the field for expiration in the registrar management table 522.

The data collection unit 500 refers to the targeted malicious domain list 513 to set the targeted malicious domain in the field for domain in the registrar management table 522. Based on the WHOIS history data relating to the targeted malicious domain, the data collection unit 500 sets a registrar used to register the above domain, in the field for registrar in the registrar management table 522.

Based on the WHOIS history data relating to the targeted malicious domain, the data collection unit 500 sets a registration time point when the above registrar registered the above domain, in the field for registration in the registrar management table 522. Based on the WHOIS history data relating to the targeted malicious domain, the data collection unit 500 sets a time point when the above registrar updated the above domain, in the field for update in the registrar management table 522. Based on the WHOIS history data relating to the targeted malicious domain, the data collection unit 500 sets the valid registration period of the above domain according to the above registrar, in the field for expiration in the registrar management table 522.

Next, an example in which the information processing device 100 generates the detection result management table 541 based on the basic data management table 521 and the registrar management table 522 will be described with reference to FIG. 8.

FIG. 8 is an explanatory diagram illustrating an example of generating the detection result management table 541. The detection result management table 541 is implemented by a storage area of the memory 302, the recording medium 305, or the like of the information processing device 100 illustrated in FIG. 3, for example.

As illustrated in FIG. 8, the detection result management table 541 has fields for feature, legitimate, wide-area type, and targeted type. In the detection result management table 541, the registrar management data is stored as a record 541-c by setting information in each field per feature. The letter c denotes any integer.

The field for feature is set with a feature that can be utilized as a criterion for determining whether or not the behavior of the diagnosis object domain corresponds to the behavior of the malicious domain. Examples of the feature include “freshness”, “name server”, “registrar”, “unnatural re-registration”, and “forward-lookup long-term delay”. The field for legitimate is set with a false positive rate as a probability that the behavior of the legitimate domain is erroneously determined to correspond to the behavior of the malicious domain when the above feature is utilized to detect the malicious domain.

The field for wide-area type is set with a detection rate as a probability that the behavior of the wide-area malicious domain is correctly determined to correspond to the behavior of the malicious domain when the above feature is utilized to detect the malicious domain. The field for targeted type is set with a detection rate as a probability that the behavior of the targeted malicious domain is correctly determined to correspond to the behavior of the malicious domain when the above feature is utilized to detect the malicious domain.

For example, the feature “freshness” is a feature to evaluate the behavior of the malicious domain from the viewpoint that the elapsed time from a time point when a domain was registered is shorter than the first threshold value. The first threshold value is, for example, one year, because legitimate domains tend to be operated for a period of time of 10 years or more. Since the elapsed time depends on, for example, a point in time when the attack was made, a time span from a reference date set based on the range of activity of the domain to a time point when the registration was made is used.

Accordingly, when the feature “freshness” is utilized, for example, if the elapsed time from a time point when a domain was registered is shorter than the first threshold value, the behavior of the domain will be determined to correspond to the behavior of the malicious domain. For this reason, the detection rate is, for example, given as the percentage of malicious domains whose elapsed times from the time point when the registration was made are shorter than the first threshold value, to a plurality of malicious domains. The false positive rate is, for example, given as the percentage of legitimate domains whose elapsed times from the time point when the registration was made are shorter than the first threshold value, to a plurality of legitimate domains.

Here, for example, conceivable statuses include that a certain malicious domain referenced when the detection rate was calculated was used several years ago, but has already disappeared at the present time point. In this case, it is preferable for the malicious domain not to set the present time point as the reference date but to set any time point contained in the range of activity of the malicious domain as the reference date. Furthermore, since the plurality of malicious domains referenced when the detection rate was calculated sometimes has different time periods of activity from each other, the set reference dates may also be different from each other.

For example, the feature “name server” is a feature to evaluate the behavior of the malicious domain from the viewpoint that a period of time during which at least one of name servers used when operating a domain was operated in a case where the name servers were switched one or more times is shorter than the second threshold value. The second threshold value is, for example, one year. The feature “name server” is, for example, a feature that a period of time during which at least one name server of a plurality of switched name servers was operated is shorter than the second threshold value.

Furthermore, the feature “name server” may be, for example, a feature that a period of time during which the name server before switching was operated is shorter than the second threshold value. In addition, the feature “name server” may be, for example, a feature that a statistical value relating to a period of time during which each name server of the plurality of switched name servers was operated is shorter than the second threshold value. For example, the statistical value is a maximum value, a minimum value, an average value, or the like. In addition, the feature “name server” may be, for example, a feature that a period of time during which each name server of the plurality of switched name servers was operated is equally shorter than the second threshold value.

Accordingly, when the feature “name server” is utilized, for example, if a period of time during which a name server used when operating a domain was operated in a case where the name servers were switched one or more times is shorter than the second threshold value, the behavior of the domain will be determined to correspond to the behavior of the malicious domain. Furthermore, when the feature “name server” is utilized, for example, if the name server used when operating a domain has not been switched even once, the behavior of the domain may be determined not to correspond to the behavior of the malicious domain.

Therefore, the detection rate is, for example, given as the percentage of malicious domains whose periods of time during which name servers used when operating the domains were operated in a case where the name servers were switched one or more times are shorter than the second threshold value, to a plurality of malicious domains. The false positive rate is, for example, given as the percentage of legitimate domains whose periods of time during which name servers used when operating the domains were operated in a case where the name servers were switched one or more times are shorter than the second threshold value, to a plurality of legitimate domains.

The feature “registrar” is, for example, a feature to evaluate the behavior of the malicious domain from the viewpoint that the remaining expiration of a domain according to a registrar used when operating the domain before the domain is re-registered is longer than the third threshold value. The third threshold value is, for example, one month.

Accordingly, when the feature “registrar” is utilized, for example, if the remaining expiration of a domain according to the registrar is longer than the third threshold value, the behavior of the domain will be determined to correspond to the behavior of the malicious domain. For this reason, the detection rate is, for example, given as the percentage of malicious domains in which the remaining expirations of the domains according to the registrars are longer than the third threshold value, to a plurality of malicious domains. The false positive rate is, for example, given as the percentage of legitimate domains in which the remaining expirations of the domains according to the registrars are longer than the third threshold value, to a plurality of legitimate domains.

The feature “unnatural re-registration” is, for example, a feature to evaluate the behavior of the malicious domain from the viewpoint that a time taken until a domain was re-registered after the domain was invalidated is longer than the fourth threshold value. The fourth threshold value is, for example, one year.

Accordingly, when the feature “unnatural re-registration” is utilized, for example, if a time taken until a domain was re-registered after the domain was invalidated is longer than the fourth threshold value, the behavior of the domain will be determined to correspond to the behavior of the malicious domain. For this reason, the detection rate is, for example, given as the percentage of malicious domains in which times taken until the domains were re-registered after the domains were invalidated are longer than the fourth threshold value, to a plurality of malicious domains. The false positive rate is, for example, given as the percentage of legitimate domains in which times taken until the domains were re-registered after the domains were invalidated are longer than the fourth threshold value, to a plurality of legitimate domains.

The feature “forward-lookup long-term delay” is, for example, a feature to evaluate the behavior of the malicious domain from the viewpoint that a time taken until the forward lookup for name resolution for a domain was carried out after the domain was registered is longer than the fifth threshold value. The fifth threshold value is, for example, one year.

Accordingly, when the feature “forward-lookup long-term delay” is utilized, for example, if a time taken until the forward lookup for name resolution for a domain was carried out is longer than the fifth threshold value, the behavior of the domain will be determined to correspond to the behavior of the malicious domain. For this reason, the detection rate is, for example, given as the percentage of malicious domains in which times taken until the forward lookup for name resolution for the domains was carried out are longer than the fifth threshold value, to a plurality of malicious domains. The false positive rate is, for example, given as the percentage of legitimate domains in which times taken until the forward lookup for name resolution for the domains was carried out are longer than the fifth threshold value, to a plurality of legitimate domains.

At this time, a case where the attacker is abusing free dynamic DNS is conceivable. In this case, a comparatively old domain registered by a legitimate business operator will be recognized as if the forward lookup for an abused subdomain is delayed. Therefore, it is preferable for the maliciousness determination unit 530 to exclude the free dynamic DNS from the processing object when utilizing the feature “forward-lookup long-term delay”.

In FIG. 8, the maliciousness determination unit 530 refers to the feature list 523 to calculate the false positive rate when it is assumed that each kind of feature is utilized for detecting the malicious domain, based on the basic data management table 521 and the registrar management table 522. The maliciousness determination unit 530 sets the calculated false positive rate in the field for legitimate in the detection result management table 541.

Furthermore, the maliciousness determination unit 530 refers to the feature list 523 to calculate the detection rate when it is assumed that each kind of feature is utilized for detecting the wide-area malicious domain, based on the basic data management table 521 and the registrar management table 522. The maliciousness determination unit 530 sets the calculated detection rate in the field for wide-area type in the detection result management table 541.

In addition, the maliciousness determination unit 530 refers to the feature list 523 to calculate the detection rate when it is assumed that each kind of feature is utilized for detecting the targeted malicious domain, based on the basic data management table 521 and the registrar management table 522. The maliciousness determination unit 530 sets the calculated detection rate in the field for targeted type in the detection result management table 541.

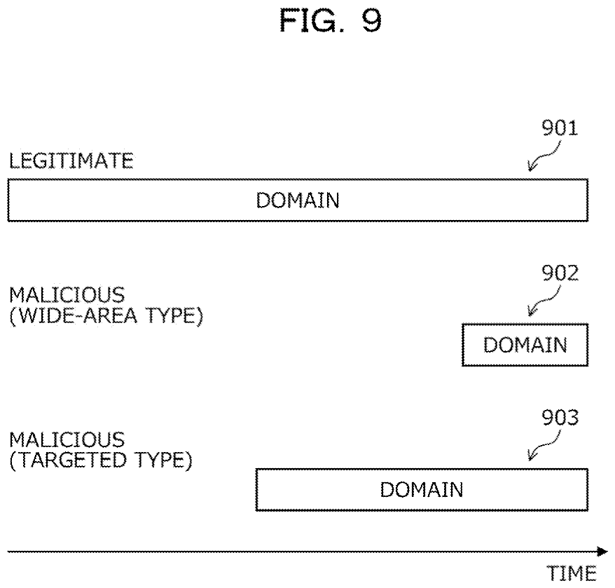

Next, an example of how the feature “freshness” appears in each of the legitimate domain, the wide-area malicious domain, and the targeted malicious domain will be described with reference to FIG. 9.

FIG. 9 is an explanatory diagram illustrating an example of how the feature “freshness” appears. As indicated by the reference numeral 901, when the domain is a legitimate domain, the domain tends to be operated over a comparatively long term, and thus the elapsed time from a time point when the domain was registered tends to be comparatively long. On the other hand, as indicated by the reference numeral 902, when the domain is a wide-area malicious domain, the domain tends to be operated in a comparatively short term and treated as disposable, and thus the elapsed time from a time point when the domain was registered tends to be comparatively short. In addition, as indicated by the reference numeral 903, when the domain is a targeted malicious domain, the domain tends to be operated over a comparatively long term by imitating the behavior of the legitimate domain, and thus the elapsed time from a time point when the domain was registered tends to be comparatively long.

Therefore, it is deemed that the feature “freshness” is utilizable as a feature that can appear in the behavior of the malicious domain. Furthermore, as illustrated in the detection result management table 541, when the feature “freshness” is utilized, the detection rate for the behavior of the wide-area malicious domain becomes comparatively high. On the other hand, since the targeted malicious domain imitates the behavior of the legitimate domain, as illustrated in the detection result management table 541, the detection rate for the behavior of the targeted malicious domain becomes comparatively low even if the feature “freshness” is utilized. Accordingly, the feature “freshness” is considered to be comparatively useful in detecting the behavior of the wide-area malicious domain.

In addition, as illustrated in the detection result management table 541, the false positive rate for the legitimate domain is equal to or less than the false positive threshold value even when the feature “freshness” is utilized. The false positive threshold value is, for example, 1%. Therefore, even if the feature “freshness” is utilized to detect the behavior of the wide-area malicious domain, it is considered possible to avoid an incident in which the behavior of the legitimate domain is erroneously determined as the behavior of the malicious domain. From these facts, the per-type feature determination unit 550 is supposed to set the feature “freshness” as a feature utilized for detecting the behavior of the wide-area malicious domain.

In contrast to this, there is a case where, depending on the first threshold value, the false positive rate for the legitimate domain becomes higher than the false positive threshold value when the feature “freshness” is utilized.

In this case, utilizing the feature “freshness” to detect the behavior of the wide-area malicious domain leads to an incident in which the behavior of the legitimate domain is erroneously determined as the behavior of the malicious domain. It is considered preferable in this case that the feature “freshness” be not utilized to detect the behavior of any type of malicious domain among the behavior of the wide-area malicious domain and the behavior of the targeted malicious domain.

In the example in FIG. 9, the per-type feature determination unit 550 is supposed to set the feature “freshness” as a feature utilized for detecting the behavior of the wide-area malicious domain. In different terms, the per-type feature determination unit 550 is supposed not to set the feature “freshness” as a feature utilized for detecting the behavior of the targeted malicious domain. Therefore, the first threshold value only needs to be a threshold value that is comparatively suitable for detecting the behavior of the wide-area malicious domain.

Accordingly, if a user of the information processing device 100 has grasped the action of the information processing device 100, the user no longer has to consider about setting the first threshold value to a comparatively small value in order to enhance the detection rate for the behavior of the targeted malicious domain. As a result, the information processing device 100 may provide an environment that allows the user of the information processing device 100 to easily restrict the false positive rate for the legitimate domain from becoming greater when the feature “freshness” is utilized.

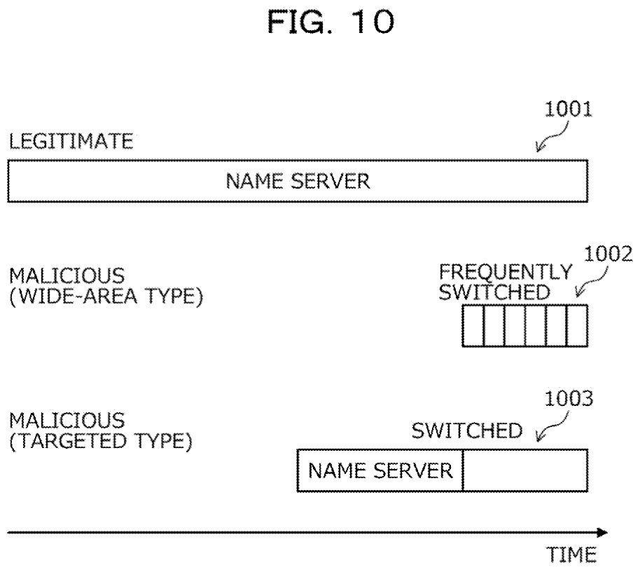

Next, an example of how the feature “name server” appears in each of the legitimate domain, the wide-area malicious domain, and the targeted malicious domain will be described with reference to FIG. 10.

FIG. 10 is an explanatory diagram illustrating an example of how the feature “name server” appears. As indicated by the reference numeral 1001, when the domain is a legitimate domain, a name server used when operating the domain tends not to be switched over a comparatively long term. Therefore, when the domain is a legitimate domain, a period of time during which the name server was operated tends to be long.

On the other hand, as indicated by the reference numeral 1002, when the domain is a wide-area malicious domain, a name server used when operating the domain tends to be frequently switched. Therefore, when the domain is a wide-area malicious domain, a name server used when operating the domain is sometimes switched one or more times, and a period of time during which each name server was operated when operating the domain tends to be comparatively short.

Furthermore, as indicated by the reference numeral 1003, when the domain is a targeted malicious domain, a name server used when operating the domain is sometimes not switched over a comparatively long term by imitating the behavior of the legitimate domain. For this reason, when the domain is a targeted malicious domain, a period of time during which the name server was operated is sometimes long as in the case of the legitimate domain.

Therefore, it is deemed that the feature “name server” is utilizable as a feature that can appear in the behavior of the malicious domain. Furthermore, as illustrated in the detection result management table 541, when the feature “name server” is utilized, the detection rate for the behavior of the wide-area malicious domain becomes comparatively high. On the other hand, since the targeted malicious domain imitates the behavior of the legitimate domain, as illustrated in the detection result management table 541, the detection rate for the behavior of the targeted malicious domain becomes comparatively low even if the feature “name server” is utilized. Accordingly, the feature “name server” is considered to be comparatively useful in detecting the behavior of the wide-area malicious domain.

In addition, as illustrated in the detection result management table 541, the false positive rate for the legitimate domain is equal to or less than the false positive threshold value even when the feature “name server” is utilized. The false positive threshold value is, for example, 1%. Therefore, even if the feature “name server” is utilized to detect the behavior of the wide-area malicious domain, it is considered possible to avoid an incident in which the behavior of the legitimate domain is erroneously determined as the behavior of the malicious domain. From these facts, the per-type feature determination unit 550 is supposed to set the feature “name server” as a feature utilized for detecting the behavior of the wide-area malicious domain.

In contrast to this, there is a case where, depending on the second threshold value, the false positive rate for the legitimate domain becomes higher than the false positive threshold value when the feature “name server” is utilized. In this case, utilizing the feature “name server” to detect the behavior of the wide-area malicious domain leads to an incident in which the behavior of the legitimate domain is erroneously determined as the behavior of the malicious domain. It is considered preferable in this case that the feature “name server” be not utilized to detect the behavior of any type of malicious domain among the behavior of the wide-area malicious domain and the behavior of the targeted malicious domain.

In the example in FIG. 10, the per-type feature determination unit 550 is supposed to set the feature “name server” as a feature utilized for detecting the behavior of the wide-area malicious domain. In different terms, the per-type feature determination unit 550 is supposed not to set the feature “name server” as a feature utilized for detecting the behavior of the targeted malicious domain. Therefore, the second threshold value only needs to be a threshold value that is comparatively suitable for detecting the behavior of the wide-area malicious domain.

Accordingly, if a user of the information processing device 100 has grasped the action of the information processing device 100, the user no longer has to consider about setting the second threshold value to a comparatively small value in order to enhance the detection rate for the behavior of the targeted malicious domain. As a result, the information processing device 100 may provide an environment that allows the user of the information processing device 100 to easily restrict the false positive rate for the legitimate domain from becoming greater when the feature “name server” is utilized.

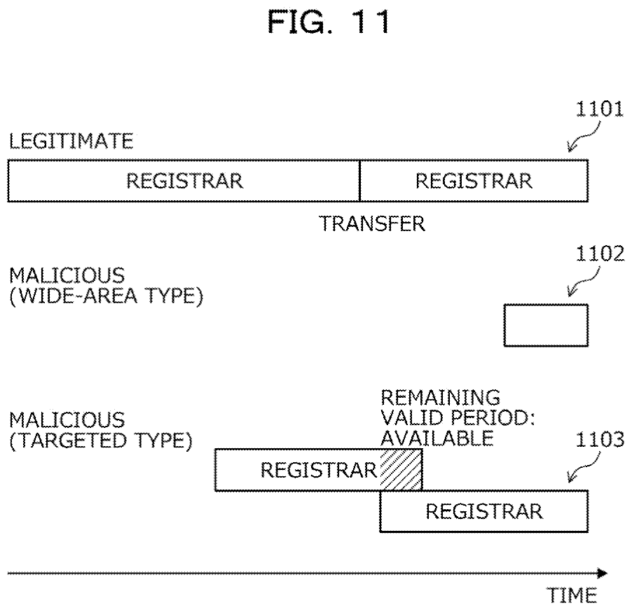

Next, an example of how the feature “registrar” appears in each of the legitimate domain, the wide-area malicious domain, and the targeted malicious domain will be described with reference to FIG. 11.

FIG. 11 is an explanatory diagram illustrating an example of how the feature “registrar” appears. As indicated by the reference numeral 1101, when the domain is a legitimate domain, a registrar used when operating the domain tends not to be switched over a comparatively long term, and thus the re-registration of the domain is unlikely to occur. Furthermore, when the domain is a legitimate domain, even if a registrar used when operating the domain is switched, the registrar tends to be switched for transfer. For example, a registrar used when operating the domain tends to be switched for transfer at a timing when the remaining expiration of the domain according to the registrar expires.

In addition, as indicated by the reference numeral 1102, when the domain is a wide-area malicious domain, an incident in which the domain is re-registered is unlikely to occur, and an incident in which a registrar used when operating the domain is switched is unlikely to occur as in the case of the legitimate domain. On the other hand, as indicated by the reference numeral 1103, when the domain is a targeted malicious domain, the domain is not treated as disposable, and the domain is sometimes re-registered. Moreover, when the domain is a targeted malicious domain, a registrar used when operating the domain is sometimes switched before the remaining expiration of the domain according to the registrar used when operating the domain expires.

Therefore, it is deemed that the feature “registrar” is utilizable as a feature that can appear in the behavior of the malicious domain. Furthermore, as illustrated in the detection result management table 541, when the feature “registrar” is utilized, the detection rate for the behavior of the targeted malicious domain becomes comparatively high. On the other hand, since an incident in which the domain is re-registered is unlikely to occur for the wide-area malicious domain, as illustrated in the detection result management table 541, the detection rate for the behavior of the wide-area malicious domain becomes comparatively low even if the feature “registrar” is utilized. Accordingly, the feature “registrar” is considered to be comparatively useful in detecting the behavior of the targeted malicious domain.

In addition, as illustrated in the detection result management table 541, the false positive rate for the legitimate domain is equal to or less than the false positive threshold value even when the feature “registrar” is utilized. The false positive threshold value is, for example, 1%. Therefore, even if the feature “registrar” is utilized to detect the behavior of the targeted malicious domain, it is considered possible to avoid an incident in which the behavior of the legitimate domain is erroneously determined as the behavior of the malicious domain. From these facts, the per-type feature determination unit 550 is supposed to set the feature “registrar” as a feature utilized for detecting the behavior of the targeted malicious domain.

In contrast to this, there is a case where, depending on the third threshold value, the false positive rate for the legitimate domain becomes higher than the false positive threshold value when the feature “registrar” is utilized. In this case, utilizing the feature “registrar” to detect the behavior of the targeted malicious domain leads to an incident in which the behavior of the legitimate domain is erroneously determined as the behavior of the malicious domain. It is considered preferable in this case that the feature “registrar” be not utilized to detect the behavior of any type of malicious domain among the behavior of the wide-area malicious domain and the behavior of the targeted malicious domain.

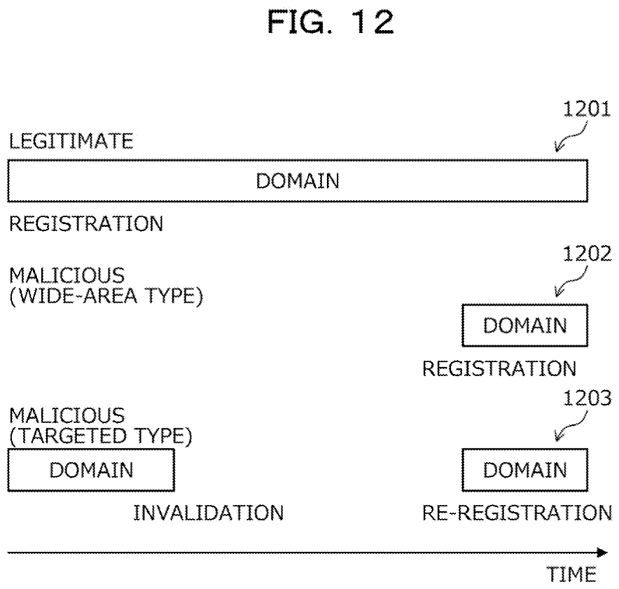

Next, an example of how the feature “unnatural re-registration” appears in each of the legitimate domain, the wide-area malicious domain, and the targeted malicious domain will be described with reference to FIG. 12.

FIG. 12 is an explanatory diagram illustrating an example of how the feature “unnatural re-registration” appears. As indicated by the reference numeral 1201, when the domain is a legitimate domain, the domain tends to be operated with care such that the domain is not invalidated in order to suppress drop catch. Furthermore, when the domain is a legitimate domain, the domain tends to be re-registered comparatively early, even if the domain is accidentally invalidated. On the other hand, as indicated by the reference numeral 1202, when the domain is a wide-area malicious domain, the domain tends to be exploited early before it is invalidated, and an incident in which the domain is re-registered after it is invalidated is unlikely to occur as in the case of the legitimate domain.

In addition, as indicated by the reference numeral 1203, when the domain is a targeted malicious domain, the domain is sometimes invalidated because the motivation to maintain the domain for the purpose of brand protection is low in some cases, and the domain is sometimes re-registered after a comparatively long period of time has elapsed since the domain was invalidated. For example, when an attacker takes movement to re-register some domains with a specified registrar at a certain specified point in time, the attacker sometimes performs unnatural behavior of re-registering a domain for which one or two years have elapsed since it was invalidated.

Therefore, it is deemed that the feature “unnatural re-registration” is utilizable as a feature that can appear in the behavior of the malicious domain. Furthermore, as illustrated in the detection result management table 541, when the feature “unnatural re-registration” is utilized, the detection rate for the behavior of the targeted malicious domain becomes comparatively high. On the other hand, the wide-area malicious domain tends to be exploited early before it is invalidated and, as illustrated in the detection result management table 541, the detection rate for the behavior of the wide-area malicious domain becomes comparatively low even if the feature “unnatural re-registration” is utilized. Accordingly, the feature “unnatural re-registration” is considered to be comparatively useful in detecting the behavior of the targeted malicious domain.

In addition, as illustrated in the detection result management table 541, the false positive rate for the legitimate domain is equal to or less than the false positive threshold value even when the feature “unnatural re-registration” is utilized. The false positive threshold value is, for example, 1%. Therefore, even if the feature “unnatural re-registration” is utilized to detect the behavior of the targeted malicious domain, it is considered possible to avoid an incident in which the behavior of the legitimate domain is erroneously determined as the behavior of the malicious domain. From these facts, the per-type feature determination unit 550 is supposed to set the feature “unnatural re-registration” as a feature utilized for detecting the behavior of the targeted malicious domain.

In contrast to this, there is a case where, depending on the fourth threshold value, the false positive rate for the legitimate domain becomes higher than the false positive threshold value when the feature “unnatural re-registration” is utilized. In this case, utilizing the feature “unnatural re-registration” to detect the behavior of the targeted malicious domain leads to an incident in which the behavior of the legitimate domain is erroneously determined as the behavior of the malicious domain. It is considered preferable in this case that the feature “unnatural re-registration” be not utilized to detect the behavior of any type of malicious domain among the behavior of the wide-area malicious domain and the behavior of the targeted malicious domain.

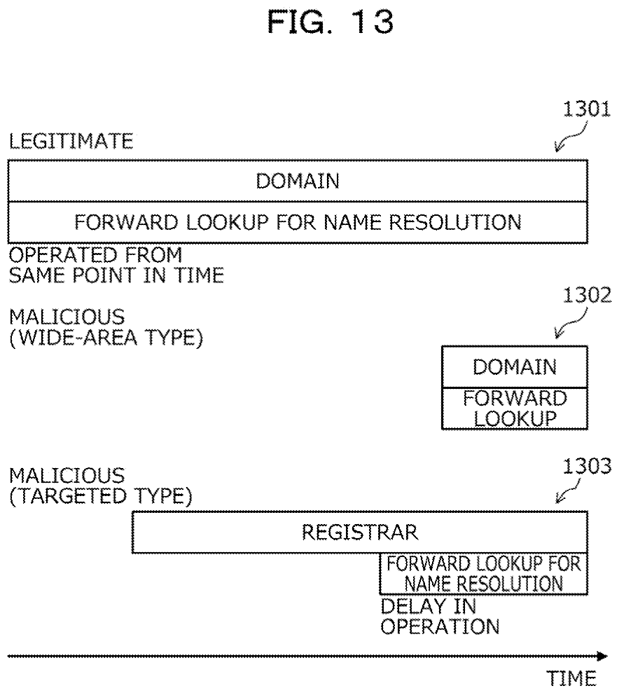

Next, an example of how the feature “forward-lookup long-term delay” appears in each of the legitimate domain, the wide-area malicious domain, and the targeted malicious domain will be described with reference to FIG. 13.

FIG. 13 is an explanatory diagram illustrating an example of how the feature “forward-lookup long-term delay” appears. As indicated by the reference numeral 1301, when the domain is a legitimate domain, the forward lookup for name resolution for the domain tends to be carried out immediately after the domain was registered. For example, “immediately after” means a few minutes, a few hours, or the like later. Furthermore, as indicated by the reference numeral 1302, when the domain is a wide-area malicious domain, the forward lookup for name resolution for the domain is sometimes carried out comparatively early after the domain was registered, as in the case of the legitimate domain.

On the other hand, as indicated by the reference numeral 1303, when the domain is a targeted malicious domain, the forward lookup for name resolution for the domain is sometimes carried out after a comparatively long time has elapsed since the domain was registered. For example, when launching an attack such as spam or Fast-Flux, an attacker sometimes starts using domains after several days or months have elapsed since the domains were collectively registered on a specified day. Furthermore, for example, an attacker sometimes secures a domain to start operating the domain after several years have elapsed.

Therefore, it is deemed that the feature “forward-lookup long-term delay” is utilizable as a feature that can appear in the behavior of the malicious domain. Furthermore, as illustrated in the detection result management table 541, when the feature “forward-lookup long-term delay” is utilized, the detection rate for the behavior of the targeted malicious domain becomes comparatively high. On the other hand, the forward lookup for name resolution for the wide-area malicious domain tends to be carried out comparatively early and, as illustrated in the detection result management table 541, the detection rate for the behavior of the wide-area malicious domain becomes comparatively low even if the feature “forward-lookup long-term delay” is utilized. Accordingly, the feature “forward-lookup long-term delay” is considered to be comparatively useful in detecting the behavior of the targeted malicious domain.

In addition, as illustrated in the detection result management table 541, the false positive rate for the legitimate domain is equal to or less than the false positive threshold value even when the feature “forward-lookup long-term delay” is utilized. The false positive threshold value is, for example, 1%. Therefore, even if the feature “forward-lookup long-term delay” is utilized to detect the behavior of the targeted malicious domain, it is considered possible to avoid an incident in which the behavior of the legitimate domain is erroneously determined as the behavior of the malicious domain. From these facts, the per-type feature determination unit 550 is supposed to set the feature “forward-lookup long-term delay” as a feature utilized for detecting the behavior of the targeted malicious domain.

In contrast to this, there is a case where, depending on the fifth threshold value, the false positive rate for the legitimate domain becomes higher than the false positive threshold value when the feature “forward-lookup long-term delay” is utilized. In this case, utilizing the feature “forward-lookup long-term delay” to detect the behavior of the targeted malicious domain leads to an incident in which the behavior of the legitimate domain is erroneously determined as the behavior of the malicious domain. It is considered preferable in this case that the feature “forward-lookup long-term delay” be not utilized to detect the behavior of any type of malicious domain among the behavior of the wide-area malicious domain and the behavior of the targeted malicious domain.

Next, an example of generating the per-type feature management table 561 will be described with reference to FIG. 14.

FIG. 14 is an explanatory diagram illustrating an example of generating the per-type feature management table 561. In FIG. 14, the per-type feature management table 561 is implemented by a storage area of the memory 302, the recording medium 305, or the like of the information processing device 100 illustrated in FIG. 3, for example.

As illustrated in FIG. 6, the per-type feature management table 561 has fields for feature, attack type, score, and ratio. In the per-type feature management table 561, per-type feature management data is stored as a record 561-c by setting information in each field per feature. The letter c denotes any integer.

The field for feature is set with a feature utilized for detecting the behavior of the malicious domain. The field for attack type is set with an attack type in a manner that makes it possible to specify which attack type the malicious domain has, of which the behavior is to be detected by utilizing the above feature. The field for score is set with a detection rate as a score that indicates the preference for utilizing the above feature for detecting the behavior of the malicious domain of the above attack type. The field for ratio is set with the ratio of a detection rate when the above feature is utilized for detecting the behavior of the malicious domain of the above attack type to a detection rate when the above feature is utilized for detecting the behavior of the malicious domain of another attack type.

In order to set the feature “freshness” as a feature utilized for detecting the behavior of the wide-area malicious domain, the per-type feature determination unit 550 sets “wide-area type” in the field for attack type in the per-type feature management table 561 in association with the feature “freshness”. Furthermore, the per-type feature determination unit 550 sets a detection rate when the feature “freshness” is utilized for detecting the behavior of the wide-area malicious domain, in the field for score in the per-type feature management table 561 in association with the feature “freshness”.

In addition, the per-type feature determination unit 550 calculates the percentage of a detection rate when the feature “freshness” is utilized for detecting the behavior of the wide-area malicious domain to a detection rate when the feature “freshness” is utilized for detecting the behavior of the targeted malicious domain. The per-type feature determination unit 550 sets the calculated percentage in the field for ratio in the per-type feature management table 561 in association with the feature “freshness”.

In order to set the feature “name server” as a feature utilized for detecting the behavior of the wide-area malicious domain, the per-type feature determination unit 550 sets “wide-area type” in the field for attack type in the per-type feature management table 561 in association with the feature “name server”. Furthermore, the per-type feature determination unit 550 sets a detection rate when the feature “name server” is utilized for detecting the behavior of the wide-area malicious domain, in the field for score in the per-type feature management table 561 in association with the feature “name server”.

In addition, the per-type feature determination unit 550 calculates the percentage of a detection rate when the feature “name server” is utilized for detecting the behavior of the wide-area malicious domain to a detection rate when the feature “name server” is utilized for detecting the behavior of the targeted malicious domain. The per-type feature determination unit 550 sets the calculated percentage in the field for ratio in the per-type feature management table 561 in association with the feature “name server”.

In order to set the feature “registrar” as a feature utilized for detecting the behavior of the targeted malicious domain, the per-type feature determination unit 550 sets “targeted type” in the field for attack type in the per-type feature management table 561 in association with the feature “registrar”. Furthermore, the per-type feature determination unit 550 sets a detection rate when the feature “registrar” is utilized for detecting the behavior of the targeted malicious domain, in the field for score in the per-type feature management table 561 in association with the feature “registrar”.

In addition, the per-type feature determination unit 550 calculates the percentage of a detection rate when the feature “registrar” is utilized for detecting the behavior of the targeted malicious domain to a detection rate when the feature “registrar” is utilized for detecting the behavior of the wide-area malicious domain. The per-type feature determination unit 550 sets the calculated percentage in the field for ratio in the per-type feature management table 561 in association with the feature “registrar”.

In order to set the feature “unnatural re-registration” as a feature utilized for detecting the behavior of the targeted malicious domain, the per-type feature determination unit 550 sets “targeted type” in the field for attack type in the per-type feature management table 561 in association with the feature “unnatural re-registration”. Furthermore, the per-type feature determination unit 550 sets a detection rate when the feature “unnatural re-registration” is utilized for detecting the behavior of the targeted malicious domain, in the field for score in the per-type feature management table 561 in association with the feature “unnatural re-registration”.

In addition, the per-type feature determination unit 550 calculates the percentage of a detection rate when the feature “unnatural re-registration” is utilized for detecting the behavior of the targeted malicious domain to a detection rate when the feature “unnatural re-registration” is utilized for detecting the behavior of the wide-area malicious domain. The per-type feature determination unit 550 sets the calculated percentage in the field for ratio in the per-type feature management table 561 in association with the feature “unnatural re-registration”.

In order to set the feature “forward-lookup long-term delay” as a feature utilized for detecting the behavior of the targeted malicious domain, the per-type feature determination unit 550 sets “targeted type” in the field for attack type in the per-type feature management table 561 in association with the feature “forward-lookup long-term delay”. Furthermore, the per-type feature determination unit 550 sets a detection rate when the feature “forward-lookup long-term delay” is utilized for detecting the behavior of the targeted malicious domain, in the field for score in the per-type feature management table 561 in association with the feature “forward-lookup long-term delay”.

In addition, the per-type feature determination unit 550 calculates the percentage of a detection rate when the feature “forward-lookup long-term delay” is utilized for detecting the behavior of the targeted malicious domain to a detection rate when the feature “forward-lookup long-term delay” is utilized for detecting the behavior of the wide-area malicious domain. The per-type feature determination unit 550 sets the calculated percentage in the field for ratio in the per-type feature management table 561 in association with the feature “forward-lookup long-term delay”.

Next, an example of determining which type of attack a malicious domain is used for with regard to the behavior of a diagnosis object domain when corresponding to the behavior of the malicious domain will be described with reference to FIGS. 15 and 16.

FIGS. 15 and 16 are explanatory diagrams illustrating an example of determining which type of attack a malicious domain is used for with regard to the behavior of a diagnosis object domain when corresponding to the behavior of the malicious domain. In FIG. 15, the unidentified domain diagnosis unit 570 acquires the per-type feature management table 561.

The unidentified domain diagnosis unit 570 collects passive DNS data relating to a first diagnosis object domain from the passive DNS data DB 514, based on the diagnosis object domain list 562. Furthermore, the unidentified domain diagnosis unit 570 collects WHOIS history data relating to the first diagnosis object domain from the WHOIS history data DB 515, based on the diagnosis object domain list 562.

The unidentified domain diagnosis unit 570 diagnoses whether or not the behavior of the first diagnosis object domain corresponds to the behavior of a malicious domain used for any type of attack associated with each kind of feature, based on the per-type feature management table 561.

The unidentified domain diagnosis unit 570 diagnoses, for example, whether or not the behavior of the first diagnosis object domain corresponds to the behavior of the wide-area malicious domain, by utilizing the feature “freshness” based on the passive DNS data and the WHOIS history data. In addition, the unidentified domain diagnosis unit 570 diagnoses, for example, whether or not the behavior of the first diagnosis object domain corresponds to the behavior of the wide-area malicious domain, by utilizing the feature “name server” based on the passive DNS data and the WHOIS history data.

In addition, the unidentified domain diagnosis unit 570 diagnoses, for example, whether or not the behavior of the first diagnosis object domain corresponds to the behavior of the targeted malicious domain, by utilizing the feature “registrar” based on the passive DNS data and the WHOIS history data. In addition, the unidentified domain diagnosis unit 570 diagnoses, for example, whether or not the behavior of the first diagnosis object domain corresponds to the behavior of the targeted malicious domain, by utilizing the feature “unnatural re-registration” based on the passive DNS data and the WHOIS history data. In addition, the unidentified domain diagnosis unit 570 diagnoses, for example, whether or not the behavior of the first diagnosis object domain corresponds to the behavior of the targeted malicious domain, by utilizing the feature “forward-lookup long-term delay” based on the passive DNS data and the WHOIS history data.

In the example in FIG. 15, it is assumed that, for example, the unidentified domain diagnosis unit 570 determines that the behavior of the first diagnosis object domain corresponds to the behavior of the wide-area malicious domain, by utilizing the feature “freshness”. Furthermore, in the example in FIG. 15, it is assumed that, for example, the unidentified domain diagnosis unit 570 determines that the behavior of the first diagnosis object domain corresponds to the behavior of the wide-area malicious domain, by utilizing the feature “name server”.

In FIG. 15, the unidentified domain diagnosis unit 570 acquires a first record of the per-type feature management table 561 relevant to the feature “freshness”, which is the basis for determining the correspondence to the behavior of the wide-area malicious domain. The first record contains the feature “freshness”, the attack type “wide-area type”, the score “95%”, and the ratio “3.8”.

In addition, the unidentified domain diagnosis unit 570 acquires a second record of the per-type feature management table 561 relevant to the feature “name server”, which is the basis for determining the correspondence to the behavior of the wide-area malicious domain. The second record contains the feature “name server”, the attack type “wide-area type”, the score “60%”, and the ratio “3.0”.

The unidentified domain diagnosis unit 570 creates a table 1500 that contains the acquired first record and the acquired second record. The unidentified domain diagnosis unit 570 transmits the created table 1500 to the client device 201 used by the security officer, and causes the client device 201 to display the transmitted table 1500.

In consequence, the unidentified domain diagnosis unit 570 may allow the security officer to refer to the attack type in the table 1500.

Therefore, the unidentified domain diagnosis unit 570 may allow the security officer to easily grasp which type of attack the malicious domain is used for with regard to the behavior of the object domain when corresponding to the behavior of the malicious domain.

Furthermore, the unidentified domain diagnosis unit 570 may allow the security officer to refer to the features in the table 1500. Therefore, the unidentified domain diagnosis unit 570 may allow the security officer to easily grasp a feature that can be the basis for determining that the behavior of the object domain corresponds to the behavior of the malicious domain.

In addition, the unidentified domain diagnosis unit 570 may allow the security officer to refer to the scores and ratios in the table 1500. Therefore, the unidentified domain diagnosis unit 570 may allow the security officer to easily grasp to what extent the feature that can be the basis for determining that the behavior of the object domain corresponds to the behavior of the malicious domain is important as a viewpoint. In this manner, the unidentified domain diagnosis unit 570 may allow the security officer to grasp the learning result by the analysis.

Therefore, the unidentified domain diagnosis unit 570 may make it easier for the security officer to take countermeasures against the attack, or make it easier for the security officer to explain to the responsible party the attack. Then, the unidentified domain diagnosis unit 570 may reduce the workload and working time imposed on the security officer. Next, a description of FIG. 16 will be made.

In FIG. 16, the unidentified domain diagnosis unit 570 acquires the per-type feature management table 561. The unidentified domain diagnosis unit 570 collects passive DNS data relating to a second diagnosis object domain from the passive DNS data DB 514, based on the diagnosis object domain list 562. Furthermore, the unidentified domain diagnosis unit 570 collects WHOIS history data relating to the second diagnosis object domain from the WHOIS history data DB 515, based on the diagnosis object domain list 562.

The unidentified domain diagnosis unit 570 diagnoses whether or not the behavior of the second diagnosis object domain corresponds to the behavior of a malicious domain used for any type of attack associated with each kind of feature, based on the per-type feature management table 561.

The unidentified domain diagnosis unit 570 diagnoses, for example, whether or not the behavior of the second diagnosis object domain corresponds to the behavior of the wide-area malicious domain, by utilizing the feature “freshness” based on the passive DNS data and the WHOIS history data. In addition, the unidentified domain diagnosis unit 570 diagnoses, for example, whether or not the behavior of the second diagnosis object domain corresponds to the behavior of the wide-area malicious domain, by utilizing the feature “name server” based on the passive DNS data and the WHOIS history data.

In addition, the unidentified domain diagnosis unit 570 diagnoses, for example, whether or not the behavior of the second diagnosis object domain corresponds to the behavior of the targeted malicious domain, by utilizing the feature “registrar” based on the passive DNS data and the WHOIS history data. In addition, the unidentified domain diagnosis unit 570 diagnoses, for example, whether or not the behavior of the second diagnosis object domain corresponds to the behavior of the targeted malicious domain, by utilizing the feature “unnatural re-registration” based on the passive DNS data and the WHOIS history data. In addition, the unidentified domain diagnosis unit 570 diagnoses, for example, whether or not the behavior of the second diagnosis object domain corresponds to the behavior of the targeted malicious domain, by utilizing the feature “forward-lookup long-term delay” based on the passive DNS data and the WHOIS history data.

In the example in FIG. 16, it is assumed that, for example, the unidentified domain diagnosis unit 570 determines that the behavior of the second diagnosis object domain corresponds to the behavior of the targeted malicious domain, by utilizing the feature “registrar”. Furthermore, in the example in FIG. 16, it is assumed that, for example, the unidentified domain diagnosis unit 570 determines that the behavior of the second diagnosis object domain corresponds to the behavior of the targeted malicious domain, by utilizing the feature “unnatural re-registration”.

In FIG. 16, the unidentified domain diagnosis unit 570 acquires a first record of the per-type feature management table 561 relevant to the feature “registrar”, which is the basis for determining the correspondence to the behavior of the targeted malicious domain. The first record contains the feature “registrar”, the attack type “targeted type”, the score “40%”, and the ratio “4.0”.

In addition, the unidentified domain diagnosis unit 570 acquires a second record of the per-type feature management table 561 relevant to the feature “unnatural re-registration”, which is the basis for determining the correspondence to the behavior of the targeted malicious domain. The second record contains the feature “unnatural re-registration”, the attack type “targeted type”, the score “20%”, and the ratio “8.0”.

The unidentified domain diagnosis unit 570 creates a table 1600 that contains the acquired first record and the acquired second record. The unidentified domain diagnosis unit 570 transmits the created table 1600 to the client device 201 used by the security officer, and causes the client device 201 to display the transmitted table 1600.

In consequence, the unidentified domain diagnosis unit 570 may allow the security officer to refer to the attack type in the table 1600. Therefore, the unidentified domain diagnosis unit 570 may allow the security officer to easily grasp which type of attack the malicious domain is used for with regard to the behavior of the object domain when corresponding to the behavior of the malicious domain.

Furthermore, the unidentified domain diagnosis unit 570 may allow the security officer to refer to the features in the table 1600. Therefore, the unidentified domain diagnosis unit 570 may allow the security officer to easily grasp a feature that can be the basis for determining that the behavior of the object domain corresponds to the behavior of the malicious domain.

In addition, the unidentified domain diagnosis unit 570 may allow the security officer to refer to the scores and ratios in the table 1600. Therefore, the unidentified domain diagnosis unit 570 may allow the security officer to easily grasp to what extent the feature that can be the basis for determining that the behavior of the object domain corresponds to the behavior of the malicious domain is important as a viewpoint. In this manner, the unidentified domain diagnosis unit 570 may allow the security officer to grasp the learning result by the analysis.

Therefore, the unidentified domain diagnosis unit 570 may make it easier for the security officer to take countermeasures against the attack, or make it easier for the security officer to explain to the responsible party the attack. Then, the unidentified domain diagnosis unit 570 may reduce the workload and working time imposed on the security officer. Furthermore, the security officer may grasp that the security officer is being subjected to a targeted attack using a targeted malicious domain and may preferentially take countermeasures.

Here, in the examples in FIGS. 15 and 16, a case where the behavior of the diagnosis object domain is determined to correspond to only one of the behavior of the wide-area malicious domain and the behavior of the targeted malicious domain has been described, but the present embodiment is not limited to this case. For example, there may be a case where the behavior of the diagnosis object domain is determined to correspond to both of the behavior of the wide-area malicious domain and the behavior of the targeted malicious domain.

In this case, the unidentified domain diagnosis unit 570 may preferentially handle a determination result that has utilized a feature having the greatest ratio. It is considered that the greater the ratio, the higher the effect of distinguishing the type of attack. The unidentified domain diagnosis unit 570 selects, for example, a feature having the greatest ratio among a feature that is the basis for determining the correspondence to the behavior of the wide-area malicious domain and a feature that is the basis for determining the correspondence to the behavior of the targeted malicious domain. Then, the unidentified domain diagnosis unit 570 handles, for example, that the behavior of the diagnosis object domain corresponds to the behavior of the wide-area malicious domain or the behavior of the targeted malicious domain relevant to the selected feature.

In this manner, the information processing device 100 may be allowed to selectively utilize a feature determined to be appropriate per type when detecting the behavior of the malicious domain, and to determine whether or not the behavior of the diagnosis object domain corresponds to the behavior of the malicious domain, per type. Therefore, the information processing device 100 may be allowed to accurately determine, per type, whether or not the behavior of the object domain corresponds to the behavior of the malicious domain.

Furthermore, the information processing device 100 may verify which feature is appropriate to utilize when detecting the behavior of the malicious domain, per type by analysis. Therefore, the information processing device 100 may be applied comparatively easily to even a case where the number of utilizable features is expanded. For example, the information processing device 100 may be applied comparatively easily to even a case where a utilizable feature is newly discovered and may appropriately utilize the feature. Similarly, the information processing device 100 may be applied comparatively easily to even a case where a new reference, a new condition, or the like for a feature is put in place.

(Collection Processing Procedure)

Next, an example of a collection processing procedure executed by the information processing device 100 will be described with reference to FIG. 17. The collection processing is executed, for example, by the data collection unit 500 of the information processing device 100. The collection processing is implemented by, for example, the CPU 301, a storage area of the memory 302, the recording medium 305, or the like, and the network I/F 303 illustrated in FIG. 3.

FIG. 17 is a flowchart illustrating an example of the collection processing procedure. In FIG. 17, the information processing device 100 collects the passive DNS data for each of the legitimate domain, the wide-area malicious domain, and the targeted malicious domain, and saves the collected passive DNS data in the basic data management table 521 (step S1701).

Next, the information processing device 100 collects the WHOIS history data for each of the legitimate domain, the wide-area malicious domain, and the targeted malicious domain, and saves the collected WHOIS history data in the basic data management table 521 (step S1702).

Then, the information processing device 100 collects the registrar management data for each of the legitimate domain, the wide-area malicious domain, and the targeted malicious domain, and saves the collected registrar management data in the registrar management table 522 (step S1703). Thereafter, the information processing device 100 ends the collection processing.

(Test Processing Procedure)

Next, an example of a test processing procedure executed by the information processing device 100 will be described with reference to FIG. 18.

The test processing is executed, for example, by the maliciousness determination unit 530 of the information processing device 100. The test processing is implemented by, for example, the CPU 301, a storage area of the memory 302, the recording medium 305, or the like, and the network I/F 303 illustrated in FIG. 3.

FIG. 18 is a flowchart illustrating an example of the test processing procedure. In FIG. 18, the information processing device 100 performs maliciousness determination from the viewpoint of freshness for each of the legitimate domain, the wide-area malicious domain, and the targeted malicious domain, based on the basic data management table 521 (step S1801). At this time, the information processing device 100 calculates the detection rate and the false positive rate based on the result of performing the maliciousness determination, and saves the calculated detection rate and false positive rate in the detection result management table 541.

Next, the information processing device 100 performs maliciousness determination from the viewpoint of name server for each of the legitimate domain, the wide-area malicious domain, and the targeted malicious domain, based on the basic data management table 521 (step S1802). At this time, the information processing device 100 calculates the detection rate and the false positive rate based on the result of performing the maliciousness determination, and saves the calculated detection rate and false positive rate in the detection result management table 541.

Then, the information processing device 100 performs maliciousness determination from the viewpoint of registrar for each of the legitimate domain, the wide-area malicious domain, and the targeted malicious domain, based on the basic data management table 521 (step S1803). At this time, the information processing device 100 calculates the detection rate and the false positive rate based on the result of performing the maliciousness determination, and saves the calculated detection rate and false positive rate in the detection result management table 541.

Next, the information processing device 100 performs maliciousness determination from the viewpoint of unnatural re-registration for each of the legitimate domain, the wide-area malicious domain, and the targeted malicious domain, based on the registrar management table 522 (step S1804). At this time, the information processing device 100 calculates the detection rate and the false positive rate based on the result of performing the maliciousness determination, and saves the calculated detection rate and false positive rate in the detection result management table 541.

Then, the information processing device 100 performs maliciousness determination from the viewpoint of forward-lookup long-term delay for each of the legitimate domain, the wide-area malicious domain, and the targeted malicious domain, based on the basic data management table 521 (step S1805). At this time, the information processing device 100 calculates the detection rate and the false positive rate based on the result of performing the maliciousness determination, and saves the calculated detection rate and false positive rate in the detection result management table 541. Thereafter, the information processing device 100 ends the test processing.

(Comparison Processing Procedure)

Next, an example of a comparison processing procedure executed by the information processing device 100 will be described with reference to FIG. 19. The comparison processing is executed, for example, by the per-type feature determination unit 550 of the information processing device 100. The comparison processing is implemented by, for example, the CPU 301, a storage area of the memory 302, the recording medium 305, or the like, and the network I/F 303 illustrated in FIG. 3.

FIG. 19 is a flowchart illustrating an example of the comparison processing procedure. In FIG. 19, the information processing device 100 determines whether or not there is a feature that has not yet been selected among a plurality of kinds of features registered in the feature list (step S1901).

Here, when all kinds of features have already been selected (step S1901: No), the information processing device 100 ends the comparison processing. On the other hand, when there is a feature that has not been selected yet (step S1901: Yes), the information processing device 100 proceeds to processing in step S1902.

In step S1902, the information processing device 100 selects one feature that has not yet been selected, from among the plurality of kinds of features registered in the feature list (step S1902). Then, the information processing device 100 determines whether or not the false positive rate for the legitimate domain is equal to or less than the set false positive threshold value (step S1903).

Here, when the false positive rate is greater than the false positive threshold value (step S1903: No), the information processing device 100 returns to the processing in step S1901. On the other hand, when the false positive rate is equal to or less than the false positive threshold value (step S1903: Yes), the information processing device 100 proceeds to processing in step S1904.

In step S1904, the information processing device 100 compares the detection rates of the wide-area malicious domain and the targeted malicious domain. Based on the result of the comparison, the information processing device 100 saves the selected feature in the per-type feature management table 561 in association with one of the attack types of the malicious domains whose detection rate is relatively great (step S1904). Then, the information processing device 100 returns to the processing in step S1901.

(Diagnostic Processing Procedure)

Next, an example of a diagnostic processing procedure executed by the information processing device 100 will be described with reference to FIG. 20. The diagnostic processing is executed, for example, by the unidentified domain diagnosis unit 570 of the information processing device 100. The diagnostic processing is implemented by, for example, the CPU 301, a storage area of the memory 302, the recording medium 305, or the like, and the network I/F 303 illustrated in FIG. 3.

FIG. 20 is a flowchart illustrating an example of the diagnostic processing procedure. In FIG. 20, the information processing device 100 collects the passive DNS data and the WHOIS history data for each diagnosis object domain of the diagnosis object domains registered in the diagnosis object domain list (step S2001).

Next, the information processing device 100 performs maliciousness determination for each of the diagnosis object domains registered in the diagnosis object domain list, based on each kind of feature of the plurality of kinds of features registered in the feature list (step S2002).

Then, the information processing device 100 outputs each diagnosis object domain of diagnosis object domains determined to be malicious domains, the attack type, and the detection rate, based on the per-type feature management table 561 (step S2003). Thereafter, the information processing device 100 ends the diagnostic processing.

Here, the information processing device 100 may exchange some steps of each of the flowcharts in FIGS. 17 to 20 in the processing order to execute. For example, steps S1701 to S1703 may be exchanged in the processing order. Furthermore, the information processing device 100 may omit processing in some steps of each of the flowcharts in FIGS. 17 to 20. For example, the processing in any of steps S1801 to S1805 may be omitted.

As described above, according to the information processing device 100, the malicious behavior data that indicates the behavior of a malicious domain used for each type of attack of a plurality of types of attacks may be acquired. According to the information processing device 100, the probability of detecting the behavior of the malicious domain when it is assumed that each kind of feature of a plurality of features is utilized to detect the behavior of the malicious domain used for each type of attack may be calculated based on the malicious behavior data. According to the information processing device 100, the usefulness of each kind of feature in detecting the behavior of the malicious domain used for each type of attack may be analyzed based on the calculated probability of the detection. According to the information processing device 100, it may be determined, based on the result of the analysis, which type of attack among the plurality of types of attacks the malicious domain is used for with regard to the behavior of the object domain when corresponding to the behavior of the malicious domain. In consequence, the information processing device 100 may allow to specify which type of attack among the plurality of types of attacks the malicious domain is used for with regard to the behavior of the object domain when corresponding to the behavior of the malicious domain.

According to the information processing device 100, the legitimate behavior data that indicates the behavior of the legitimate domain may be acquired. According to the information processing device 100, the probability of erroneously detecting the behavior of the legitimate domain as the behavior of the malicious domain when it is assumed that each kind of feature is utilized to detect the behavior of the malicious domain may be calculated based on the acquired legitimate behavior data. According to the information processing device 100, the usefulness of each kind of feature in detecting the behavior of the malicious domain used for each type of attack may be analyzed based on the calculated probability of the detection and the calculated probability of the erroneous detection. In consequence, the information processing device 100 may allow to more accurately specify which type of attack among the plurality of types of attacks the malicious domain is used for with regard to the behavior of the object domain when corresponding to the behavior of the malicious domain.

According to the information processing device 100, the first feature that the elapsed time from a time point when a domain was registered is shorter than the first threshold value may be adopted as one of the plurality of kinds of features. In consequence, the information processing device 100 may allow to utilize a feature that makes it easy to detect the behavior of the malicious domain used for the wide-area attack, and to make it easy to detect the behavior of the malicious domain used for the wide-area attack.

According to the information processing device 100, a feature that a period of time during which a name server used when operating a domain was operated in a case where the name servers were switched one or more times is shorter than the second threshold value may be adopted as one of the plurality of kinds of features. In consequence, the information processing device 100 may allow to utilize a feature that makes it easy to detect the behavior of the malicious domain used for the wide-area attack, and to make it easy to detect the behavior of the malicious domain used for the wide-area attack.

According to the information processing device 100, a feature that the remaining expiration of a domain according to a registrar used when operating the domain before the domain is re-registered is longer than the third threshold value may be adopted as one of the plurality of kinds of features. In consequence, the information processing device 100 may allow to utilize a feature that makes it easy to detect the behavior of the malicious domain used for the targeted attack, and to make it easy to detect the behavior of the malicious domain used for the targeted attack.

According to the information processing device 100, a feature that a time taken until a domain was re-registered after the domain was invalidated is longer than the fourth threshold value may be adopted as one of the plurality of kinds of features. In consequence, the information processing device 100 may allow to utilize a feature that makes it easy to detect the behavior of the malicious domain used for the targeted attack, and to make it easy to detect the behavior of the malicious domain used for the targeted attack.

According to the information processing device 100, a feature that a time taken until the forward lookup for name resolution for a domain was carried out after the domain was registered is longer than the fifth threshold value may be adopted as one of the plurality of kinds of features. In consequence, the information processing device 100 may allow to utilize a feature that makes it easy to detect the behavior of the malicious domain used for the targeted attack, and to make it easy to detect the behavior of the malicious domain used for the targeted attack.

According to the information processing device 100, the result of the determination may be output in association with the object domain. In consequence, the information processing device 100 may allow to easily grasp which type of attack the malicious domain is used for with regard to the behavior of the object domain when corresponding to the behavior of the malicious domain.

According to the information processing device 100, a feature relevant to the result of the determination, among the features of the respective kinds, may be output in association with the object domain. In consequence, the information processing device 100 may allow to easily grasp a feature that can be the basis for determining that the behavior of the object domain corresponds to the behavior of the malicious domain.

According to the information processing device 100, the probability of detecting the behavior of the malicious domain when it is assumed that the feature relevant to the result of the determination among the features of the respective kinds is utilized to detect the behavior of the malicious domain may be output in association with the object domain. In consequence, the information processing device 100 may allow the security officer to easily grasp to what extent the feature that can be the basis for determining that the behavior of the object domain corresponds to the behavior of the malicious domain is important as a viewpoint.

According to the information processing device 100, it may be analyzed, based on the calculated probability of the detection, which type of attack among a plurality of types of attacks a malicious domain is used for with regard to each kind of feature when being most useful in detecting the behavior of the malicious domain. This allows the information processing device 100 to specify which type of attack the malicious domain is used for with regard to each kind of feature when being most appropriate to utilize for detecting the behavior of the malicious domain. Therefore, the information processing device 100 may allow to more accurately specify which type of attack among the plurality of types of attacks the malicious domain is used for with regard to the behavior of the object domain when corresponding to the behavior of the malicious domain.

According to the information processing device 100, it may be analyzed for each kind of feature that the feature is not useful in detecting the behavior of the malicious domain used for any type of attack if the probability of the erroneous detection is equal to or higher than a predetermined probability. This allows the information processing device 100 to mitigate the need for utilizing a feature that can induce the erroneous detection. Therefore, the information processing device 100 may allow to more accurately specify which type of attack among the plurality of types of attacks the malicious domain is used for with regard to the behavior of the object domain when corresponding to the behavior of the malicious domain.

Note that the information processing method described in the present embodiment may be implemented by executing a prepared program on a computer such as a personal computer (PC) or a workstation. The information processing program described in the present embodiment is executed by being recorded on a computer-readable recording medium and being read from the recording medium by the computer. The recording medium is a hard disk, a flexible disk, a compact disc (CD)-ROM, a magneto-optical disc (MO), a digital versatile disc (DVD), or the like. Furthermore, the information processing program described in the present embodiment may be distributed via a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an information processing program that causes a processor included in a computer to execute a process the process comprising:
acquiring malicious behavior data that indicates behavior of a malicious domain used for each attack of a plurality of types of attacks;
specifying a probability of detecting the behavior of the malicious domain when each feature of a plurality of kinds of features that appears in the behavior of the malicious domain is utilized to detect the behavior of the malicious domain used for the each attack, based on the acquired malicious behavior data;
analyzing usefulness of the each feature in detecting the behavior of the malicious domain used for the each attack, based on the specified probability; and
determining which type of attack among the plurality of types of attacks the malicious domain is used for with regard to behavior of an object domain when corresponding to the behavior of the malicious domain, based on a result of the analyzing.

2. The non-transitory computer-readable recording medium according to claim 1, wherein the process further includes:
acquiring legitimate behavior data that indicates behavior of a legitimate domain; and
specifying a probability of erroneously detecting the behavior of the legitimate domain as the behavior of the malicious domain when the each feature is utilized to detect the behavior of the malicious domain, based on the acquired legitimate behavior data, wherein
the analyzing
analyzes the usefulness of the each feature in detecting the behavior of the malicious domain used for the each attack, based on the calculated probability of the detecting and the specified probability of the erroneously detecting.

3. The non-transitory computer-readable recording medium storing according to claim 1, wherein the plurality of kinds of features includes a feature that an elapsed time from a time point when a domain was registered is shorter than a first threshold value.

4. The non-transitory computer-readable recording medium according to claim 1, wherein the plurality of kinds of features includes a feature that a period of time during which one of name servers used when operating a domain was operated in a case where the name servers were switched one or more times is shorter than a second threshold value.

5. The non-transitory computer-readable recording medium according to claim 1, wherein the plurality of kinds of features includes a feature that a remaining expiration of a domain according to a registrar used when operating the domain before the domain is re-registered is longer than a third threshold value.

6. The non-transitory computer-readable recording medium according to claim 1, wherein the plurality of kinds of features includes a feature that a time taken until a domain was re-registered after the domain was invalidated is longer than a fourth threshold value.

7. The non-transitory computer-readable recording medium according to claim 1, wherein the plurality of kinds of features includes a feature that a time taken until forward lookup for name resolution for a domain was carried out after the domain was registered is longer than a fifth threshold value.

8. The non-transitory computer-readable recording medium according to claim 1, wherein the process further includes:
outputting a result of the determining in association with the object domain.

9. The non-transitory computer-readable recording medium according to claim 1, wherein the process further includes:
outputting a feature among the plurality of kinds of features relevant to a result of the determining in association with the object domain.

10. The non-transitory computer-readable recording medium according to claim 1, wherein the process further incudes:
outputting the probability of detecting the behavior of the malicious domain when a feature relevant to a result of the determining among the plurality of kinds of features is utilized to detect the behavior of the malicious domain, in association with the object domain.

11. The non-transitory computer-readable recording medium according to claim 1, wherein the analyzing includes analyzing which type of attack among the plurality of types of attacks the malicious domain is used for with regard to the each feature when being most useful in detecting the behavior of the malicious domain, based on the calculated probability of the detecting.

12. The non-transitory computer-readable recording medium according to claim 2, wherein the analyzing includes analyzing, for the each feature, that the feature is not useful in detecting the behavior of the malicious domain used for any type of attack among the plurality of types of attacks when the calculated probability of the erroneously detecting is equal to or higher than a predetermined probability.

13. An information processing method comprising:
acquiring malicious behavior data that indicates behavior of a malicious domain used for each attack of a plurality of types of attacks;
specifying a probability of detecting the behavior of the malicious domain when each feature of a plurality of kinds of features that appears in the behavior of the malicious domain is utilized to detect the behavior of the malicious domain used for the each attack, based on the acquired malicious behavior data;
analyzing usefulness of the each feature in detecting the behavior of the malicious domain used for the each attack, based on the specified probability; and
determining which type of attack among the plurality of types of attacks the malicious domain is used for with regard to behavior of an object domain when corresponding to the behavior of the malicious domain, based on a result of the analyzing.

14. An information processing device comprising:
a memory; and
a processor coupled to the memory and configured to:
acquire malicious behavior data that indicates behavior of a malicious domain used for each attack of a plurality of types of attacks,
specify a probability of detecting the behavior of the malicious domain when each feature of a plurality of kinds of features that appears in the behavior of the malicious domain is utilized to detect the behavior of the malicious domain used for the each attack, based on the acquired malicious behavior data,
analyze usefulness of the each feature in detecting the behavior of the malicious domain used for the each attack, based on the specified probability, and
determine which type of attack among the plurality of types of attacks the malicious domain is used for with regard to behavior of an object domain when corresponding to the behavior of the malicious domain, based on a result of the analyzing.
